(19) United States
(12) Patent Application Publication
(10) Pub. No.: US 2016/0231657 A1
(43) Pub. Date: Aug. 11, 2016

(54) Electrophotographic Photoreceptor, Process Cartridge and Image Forming Apparatus

(71) Applicant: FUJI XEROX CO., LTD., Tokyo (JP)

(72) Inventors: Masahiko MIYAMOTO, Ebina-shi (JP); Shigeto HASHIBA, Ebina-shi (JP)

(73) Assignee: FUJI XEROX CO., LTD., Tokyo (JP)

(21) Appl. No.: 14/819,954

(22) Filed: Aug. 6, 2015

(30) Foreign Application Priority Data
Feb. 5, 2015 (JP) 2015-021157
Mar. 25, 2015 (JP) 2015-063301
Mar. 25, 2015 (JP) 2015-063304

(51) Int. Cl. G03G 15/00

(52) U.S. Cl. CPC G03G 5/0614; G03G 5/0564; G03G 5/0696

(57) ABSTRACT

According to an exemplary embodiment of the present invention, there is provided an electrophotographic photoreceptor having a conductive substrate, and a photosensitive layer arranged on the conductive substrate, wherein the photosensitive layer contains a charge-generating material, a charge-transporting material having a specific structure, a charge-transporting material having another specific structure, and at least one selected from a group consisting of a hindered phenol antioxidant having a molecular weight of 300 or more and a benzophenone UV absorbent.

### CROSS-REFERENCE TO RELATED APPLICATION(S)

This application is based on and claims priority under 35 U.S.C. 119 from Japanese Patent Application Nos. 2015-021157 filed on Feb. 5, 2015, 2015-063301 filed on Mar. 25, 2015, and 2015-063304 filed on Mar. 25, 2015.

### BACKGROUND

1. Technical Field

The present invention relates to an electrophotographic photoreceptor, a process cartridge and an image forming apparatus.

2. Background Art

Heretofore, as an electrophotographic image forming apparatus, there has been widely known a device that carries out sequentially steps of charging, electrostatic image formation, development, transfer, cleaning and the like, using an electrophotographic photoreceptor (hereinafter this may be referred to as “photoreceptor”).

As the electrophotographic photoreceptor, there are known a function separation-type photosensitizer including, as laminated on a conductive substrate of aluminum or the like, a charge generation layer of generating charges and a charge transport layer of transporting charges, and a single-layer photosensitizer in which one and the same layer fulfill a function of generating charges and a function of transporting charges.

### SUMMARY

According to one aspect of the invention there is provided an electrophotographic photoreceptor including:

a conductive substrate, and

a photosensitive layer arranged on the conductive substrate, wherein the photosensitive layer contains a charge-generating material, a charge-transporting material represented by the following general formula (CT1), a charge-transporting material represented by the following general formula (CT2), and at least one selected from a group consisting of a hindered phenol antioxidant having a molecular weight of 300 or more and a benzophenone UV absorbent.

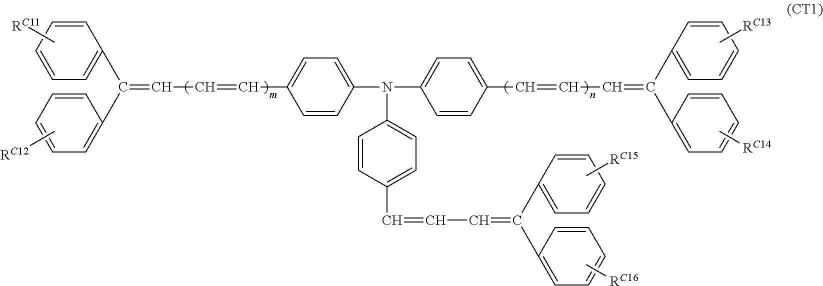

(In the general formula (CT1), R^{C11}, R^{C12}, R^{C13}, R^{C14}, R^{C15} and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, and the adjacent two substituents may bond to each other to form a hydrocarbon-cyclic structure. n and m each independently indicate 0, 1 or 2.)

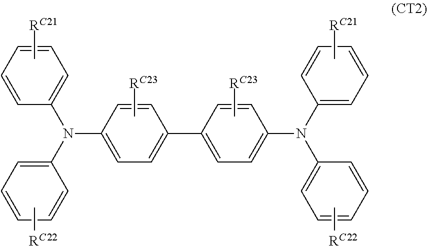

(In the general formula (CT2), R^{C21}, R^{C22} and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.)

### BRIEF DESCRIPTION OF THE DRAWINGS

Exemplary embodiments of the present invention will de described in detail based on the following figures, wherein:

FIG. 1 is a schematic sectional view showing one example of a layer configuration of an electrophotographic photoreceptor of an embodiment of the present invention;

FIG. 2 is a skeleton framework view showing one example of an image forming apparatus of an embodiment of the present invention; and

FIG. 3 is a skeleton framework view showing another example of an image forming apparatus of an embodiment of the present invention.

### DETAILED DESCRIPTION

Embodiments of the present invention are described hereinunder with reference to the attached drawings. In the drawings, the same reference number is given to the component having a similar function to omit any reductant description.

### [Electrophotographic Photoreceptor]

The electrophotographic photoreceptor (hereinafter also referred to as “photoreceptor”) of this embodiment has a conductive substrate and a photosensitive layer arranged on the conductive substrate. The photosensitive layer contains a charge-generating material, a charge-transporting material represented by the general formula (CT1) (hereinafter also referred to as “butadiene charge-transporting material (CT1)”), a charge-transporting material represented by the general formula (CT2) (hereinafter also referred to as “benzidine charge-transporting material (CT2)”), and at least one selected from a group consisting of a hindered phenol antioxidant having a molecular weight of 300 or more (hereinafter also simply referred to as “hindered phenol antioxidant”) and a benzophenone UV absorbent.

In one preferred embodiment of the photoreceptor, the photosensitive layer contains a biphenyl copolymer-type polycarbonate resin containing a structural unit having a biphenyl skeleton (hereinafter also referred to as “BP polycarbonate resin”).

In another embodiment, the photosensitive layer contains fluorine-containing resin particles and a fluorine-containing dispersant.

Here, the photosensitive layer may contain both a BP polycarbonate resin and “fluorine-containing resin particles and a fluorine-containing dispersant”.

The photosensitive layer may be either a function separation-type photosensitive layer having a charge generation layer and a charge transport layer, or a single-layer photosensitive layer. In a case of the function separation-type photosensitive layer, the charge generation layer contains a charge-generating agent, and the charge transport layer contains a butadiene charge-transporting material (CT1), a benzidine charge-transporting material (CT2), and at least one selected from a group consisting of a hindered phenol antioxidant and a benzophenone UV absorbent.

In this case, the BP polycarbonate resin, or the fluorine-containing resin particles and the fluorine-containing dispersant is/are contained in the charge transport layer.

Having the constitution as above, the electrophotographic photoreceptor of this embodiment solves a problem of burn-in ghosting to occur in continuous outputting of a same image and solves a problem of optical fatigue to occur in photoexposure. The reason may be presumed as follows.

First, the butadiene charge-transporting material (CT1) has a high charge mobility and is suitable for obtaining a photosensitive layer (or a charge transport layer) having high charge transportability. On the other hand, the butadiene charge-transporting material (CT1) has a property that its solubility in solvent is low. Consequently, for obtaining a photosensitive layer having high charge transportability, it is desirable to combine the butadiene charge-transporting material (CT1) and the benzidine charge-transporting material (CT2) having a relatively high charge mobility and having a high solubility in solvent.

However, when a same image is continuously outputted (for example, in continuous outputting of 3000 copies) using a photoreceptor having a photosensitive layer that contains both the butadiene charge-transporting material (CT1) and the benzidine charge-transporting material (CT2) and then, for example, when a full-page halftone image is thereafter outputted using the photoreceptor, then the surface potential of a part of the photoreceptor that has been continuously exposed in the same image outputting operation lowers, and there may occur a problem of an image defect (positive ghost) that is referred to as “burn-in ghost” having an increased density.

In addition, when the photoreceptor is exposed to environmental light such as room light or sunlight in exchanging it for a new one, the chargeability of a part of the photoreceptor that has been exposed to the environmental light would lower, and therefore, when a full-page halftone image is outputted using the photoreceptor, then there may occur an image defect that is referred to as “optical fatigue” of such that the image density in the photoexposed part stands out thickly.

The reason of the image defects that are referred to as “burn-in ghost” and “optical fatigue” is considered to be that, owing to the continuous outputting of a same image and to the environmental light exposure, electrons would be readily excited in the electron-delocalized region where the electrons contributing toward injection of charges from the charge-generating material to the charge-transporting material in a photosensitive layer and toward movement of charges in the charge-transporting material are delocalized. In other words, it is considered that the image defects would be generated owing to the increase in the image density to be caused by the reduction in the charge potential in the region that has been continuously exposed in continuous outputting of a same image and in the region that has been exposed to the environmental light, through activation of the charge generation and the charge injection.

The image density increase owing to the charge potential reduction is especially remarkable when the photosensitive layer contains both the butadiene charge-transporting material (CT1) and the benzidine charge-transporting material (CT2). This is considered because the butadiene charge-transporting material (CT1) has structurally high-level charge transportability and has a large electron-delocalized region in the molecule, therefore providing an interaction between the benzidine charge-transporting material (CT2) and a charge-generating material, and the charge potential reduction in the continuous outputting of a same image and in the environmental light exposure would be thereby remarkable.

In a case where a BP polycarbonate resin as a binder resin is contained in the photosensitive layer, the abrasion resistance of the layer may be improved and the life of the photoreceptor could be thereby prolonged. However, even a photoreceptor that has a photosensitive layer containing a BP polycarbonate resin would be often troubled by “burn-in ghost” and “optical fatigue”. It is considered that the benzene ring of the biphenyl skeleton of a RP polycarbonate resin could interact with a charge-transporting material and therefore could readily act as a charge trap site (a region where charges may readily accumulate). When charges are excessively accumulated in a photosensitive layer owing to the presence of the charge trap site therein, it is considered that “burn-in ghost” and “optical fatigue” would be remarkable since those charges would be offset by the charges accumulated on the surface of the photoreceptor after charged.

Further, in a case where fluorine-containing resin particles and a fluorine-containing dispersant are contained in the photosensitive layer, the abrasion resistance of the photosensitive layer may be improved and the life of the photoreceptor could be thereby prolonged. On the other hand, when the photosensitive layer contains a fluorine-containing dispersant, it is considered that the fluorine-containing dispersant may readily act as a charge trap site (a region where charges may readily accumulate). When charges are excessively accumulated in a photosensitive layer owing to the presence of the charge trap site therein, it is considered that “burn-in ghost” and “optical fatigue” would be remarkable since those charges would be offset by the charges accumulated on the surface of the photoreceptor after charged. This phenomenon may be more remarkable in a case where the amount of the fluorine-containing dispersant to be in the layer is large.

As opposed to the above, when a hindered phenol antioxidant is further contained in the photosensitive layer containing the butadiene charge-transporting layer (CT1) and the benzidine charge-transporting layer (CT2), the charge potential reduction owing to the continuous output of a same image and the environmental light exposure could be retarded. This is considered because the hindered phenol antioxidant could provide interaction such as charge transfer in the electron-delocalized region, therefore retarding the change in the electron energy state in the electron-delocalized region that has been formed through the continuous outputting of a same image and the environmental light exposure. In addition, in a case where the molecular weight of the hindered phenol antioxidant is 300 or more, the hindered phenol antioxidant of the type can be prevented from evaporating away in the drying step in the process of forming the photosensitive layer. In other words, when the molecular weight of the hindered phenol antioxidant is 300 or more, it is considered that the hindered phenol antioxidant could remain in the photosensitive layer in the amount thereof capable of expressing the above-mentioned function.

On the other hand, even in a case where a benzophenone UV absorbent is contained in the photosensitive layer containing both the butadiene charge-transporting material (CT1) and the benzidine charge-transporting material (CT2), the charge potential reduction owing to the continuous outputting of a same image and the environmental light exposure may be retarded. This is considered because the benzophenone UV absorbent could absorb the light energy that the photosensitive layer receives though the continuous outputting of a same image and the environmental light exposure, and therefore in the electron-delocalized region, the electron energy state change could be thereby retarded.

Further, in a case where the photosensitive layer contains a BP polycarbonate resin, it is considered that the hindered phenol antioxidant and the benzophenone UV absorbent could react both on the benzene ring of the biphenyl skeleton of the BP polycarbonate and on the charge-transporting material, and therefore the formation of a charge trap site owing to the interaction between the benzene ring of the biphenyl skeleton and the charge-transporting material could be thereby retarded. Consequently, it is considered that any excessive accumulation of charges in the photosensitive layer to be caused by the charge trap site resulting from the interaction between the benzene ring of the biphenyl skeleton and the charge-transporting material could be thereby retarded.

From the above, it is presumed that the electrophotographic photoreceptor of this embodiment can solve the problem of burn-in ghosting to occur in continuous outputting of a same image and can solve the problem of optical fatigue to occur in photoexposure.

In addition, in a case where a hydroxygallium phthalocyanine pigment is contained in the photosensitive layer as the charge-generating material therein, the amount of the charges to be generated is large, and therefore in the case, the charge potential reduction owing to continuous outputting of a same image and environmental light exposure may be remarkable, and therefore there may readily occur troubles of burn-in ghosting and optical fatigue. However, even in a case where a hydroxygallium phthalocyanine is contained in the photosensitive layer in the electrophotographic photoreceptor of this embodiment, the photoreceptor still can solve the problem of burn-in ghosting to occur in continuous outputting of a same image and can solve the problem of optical fatigue to occur in photoexposure.

The electrophotographic photoreceptor of this embodiment is described hereinunder with reference to the drawings.

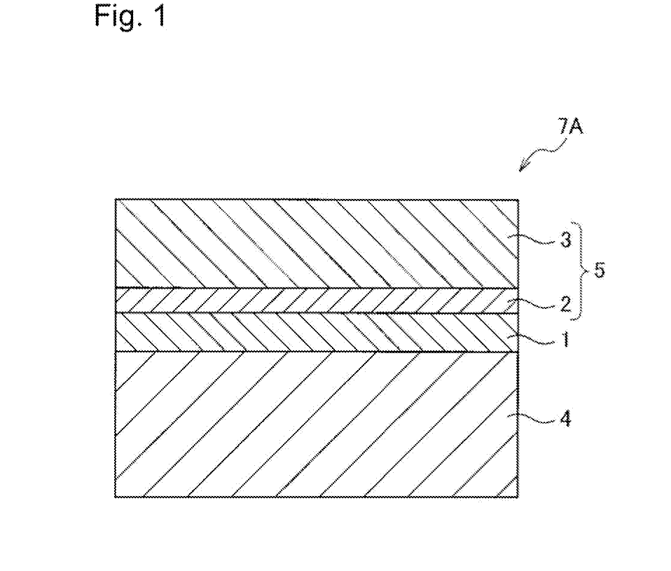

FIG. 1 is a schematic sectional view showing one example of a layer configuration of an electrophotographic photoreceptor 7A of this embodiment. The electrophotographic photoreceptor 7A shown in FIG. 1 has a configuration of an undercoat layer, 1, a charge generation layer 2 and a charge transport layer 3 laminated in this order on a conductive substrate 4. The charge generation layer 2 and the charge transport layer 3 constitutes the photosensitive layer 5.

The electrophotographic photoreceptor 7A may have a layer configuration not having the undercoat layer 1. The electrophotographic photoreceptor 7A may also have a layer configuration further having a protective layer on the charge transport layer 3. The electrophotographic photoreceptor 7A may have a single-layer photosensitive layer in which the function of the charge generation layer 2 is integrated with that of the charge transport layer 3.

The components of the electrophotographic photoreceptor are described below. In the following description, the reference number of each component is omitted.

### (Conductive Substrate)

As the conductive substrate, for example, there are mentioned metal plates, metal drums, metal belts and the like containing any of metals (aluminum, copper, zinc, chromium, nickel, molybdenum, vanadium, indium, gold, platinum, or the like) or alloys (stainless steel, or the like). As the conductive substrate, for example, there are also mentioned papers, resin films, belts and the like coated, vapor-deposited or laminated with any of conductive compounds (for example, conductive polymers, indium oxide, or the like), metals (for example, aluminum, palladium, gold, or the like) or alloys. Here, “conductive” is meant to indicate a substance of which the volume resistivity is less than 10¹³ Ωcm.

The surface of the conductive substrate is preferably so roughened that the center line mean roughness Ra thereof could be from 0.04 μm to 0.5 μm for the purpose of preventing interference fringes from forming in laser light irradiation when the electrophotographic photoreceptor is used in a laser printer. In a case where non-interference light is used as the light source here, roughening for prevention of interference fringes is not especially necessary but is preferred for prolonging the life of the photoreceptor as capable of preventing the generation of defects owing to the surface irregularities of the conductive substrate.

As the surface roughening method, for example, there are mentioned a wet honing method of spraying a suspension of an abrasive in water onto a conductive substrate, a centerless grinding method of pressing a conductive substrate against a rotating grinding stone to continuously grind the substrate, a method of anodic oxidation treatment of a conductive substrate, or the like.

As the surface roughening method, there is also mentioned a method of forming a layer of a conductive or semiconductive power as dispersed in a resin, on the surface of a conductive substrate, not roughening the surface of the conductive substrate, in which the conductive substrate may have a roughened surface owing to the particles dispersed in the layer. As the layer for surface roughening, also employable here is the undercoat layer to be described hereinunder.

The surface roughening treatment through anodic oxidation is to form an oxide film on the surface of a metallic conductive substrate (of, for example, aluminum) through anodic oxidation of the conductive substrate in an electrolytic solution in which the substrate serves as an anode. As the electrolytic solution, for example, there are mentioned a sulfuric acid solution, an oxalic acid solution, or the like. However, the porous oxide film formed through such anodic oxidation is chemically active as it is, and is therefore readily stained and, in addition, the environment-dependent resistance fluctuation thereof is great. Consequently, it is desirable that the porous oxide film formed through anodic oxidation is processed for sealing treatment of such that the fine pores of the oxide film are sealed up through volume expansion by hydration in pressurized steam or boiling water (to which a metal salt with nickel or the like may be added, if desired) to thereby convert the film into a more stable hydrated oxide film.

It is desirable that the thickness of the anodic oxide film is, for example, from 0.3 μm to 15 μm. When the film thickness falls within the range, the film tends to exhibit barrier performance against injection, and tends to prevent the residual potential thereof from increasing in repeated use.

The conductive substrate may be subjected to treatment with an acidic treating liquid or to boehmite treatment.

The treatment with an acidic treating liquid may be carried out, for example, as follows. First, an acidic treating solution containing phosphoric acid, chromic acid and hydrofluoric acid is prepared. The blending ration of phosphoric acid, chromic acid and hydrofluoric acid in the acidic treating liquid is, for example, such that the amount of the phosphoric acid falls within a range of from 10% by weight to 11% by weight, the amount of chromic acid is within a range of from 3% by weight to 5% by weight, and the amount of hydrofluoric acid is within a range of from 0.5% by weight to 2% by weight, and the total concentration of those acids is preferably within a range of from 13.5% by weight to 18% by weight. The treatment temperature is preferably from 42° C. to 48° C. The thickness of the coating film is preferably from 0.3 μm to 15 μm.

The boehmite treatment may be carried out, for example, by immersing the substrate in pure water at from 90° C. to 100° C. for 5 minutes to 60 minutes, or by bringing the substrate into contact with hot steam at from 90° C. to 120° C. for 5 minutes to 60 minutes. The thickness of the coating film is preferably from 0.1 μm to 5 μm. This may be further processed for anodic oxidation treatment using a solution of an electrolyte that may hardly dissolve the coating film, such as adipic acid, boric acid, borate, phosphate, phthalate, maleate, benzoate, tartrate, citrate or the like.

### (Undercoat Layer)

The undercoat layer is, for example, a layer containing inorganic particles and a binder resin.

The inorganic particles are, for example, those having a powder resistance (volume resistivity) of from 102 Ωcm to 10¹¹ Ωcm.

Above all, as the inorganic particles having the above-mentioned resistance value, for example, preferred are metal oxide particles such as tin oxide particles, titanium oxide particles, zinc oxide particles, zirconium oxide particles. Especially preferred are zinc oxide particles.

The specific surface area, as measured according to a BET method, of the inorganic particles is, for example, preferably 10 m²/g or more.

The volume-average particle size of the inorganic particles is, for example, preferably from 50 nm to 2000 nm (more preferably from 60 nm to 1000 nm).

The content of the inorganic particles is, for example, preferably from 10% by weight to 80% by weight relative to the binder resin, more preferably from 40% by weight to 80% by weight.

The inorganic particles may be surface-treated. Two or more different types of inorganic particles that differ in point of the mode of surface treatment applied thereto or differ in point of the particle size thereof may be combined for use herein.

The surface-treating agent includes, for example, a silane coupling agent, a titanate coupling agent, an aluminum coupling agent, a surfactant, and the like. In particular, preferred is a silane coupling agent; and more preferred is a silane coupling agent having an amino group.

The silane coupling agent having an amino group includes, for example, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and the like, to which, however, the present invention is not limited.

Two or more different types of silane coupling agents may be used here as combined. For example, a silane coupling agent having an amino group may be combined with any other silane coupling agent for use herein. The other silane coupling agent includes, for example, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, 3-chloropropyltrimethoxysilane, and the like, to which, however, the present invention is not limited.

The surface treatment method with a surface-treating agent may be any known method, and may be any of a dry method or a wet method.

The amount of the surface-treating agent for the treatment is preferably from 0.5% by weight to 10% by weight relative to the inorganic particles.

Here, the undercoat layer may contain an electron-accepting compound (acceptor compound) along with inorganic particles, and preferably contains the compound from the viewpoint of enhancing the long-term stability of the electric properties of the photoreceptor and enhancing the carrier-blocking performance thereof.

As the electron-accepting compound, for example, there are mentioned electron-transporting substances that include quinone compounds such as chloranil, bromanil, and the like; tetracyanoquinodimethane compounds; fluorenone compounds such as 2,4,7-trinitrofluorenone, 2,4,5,7-tetranitro-9-fluorenone; oxadiazole compounds such as 2-(4-biphenyl)-5-(4-t-butylphenyl)-1,3,4-oxadiazole, 2,5-bis(4-naphthyl)-1,3,4-oxadiazole, 2,5-bis(4-diethylaminophenyl)-1,3,4-oxadiazole; xanthone compounds; thiophene compounds; diphenoquinone compounds such as 3,3′-5,5′-tetra-t-butyldiphenoquinone.

In particular, as the electron-accepting compound, preferred is use of a compound having an anthraquinone structure. As the compound having an anthraquinone structure, for example, preferred are hydroxyanthraquinone compounds, aminoanthraquinone compounds, aminohydroxyanthraquinone compounds, and the like. Concretely, for example, preferred are anthraquinone, alizarin, quinizarin, anthrarufin, purpurin, and the like.

The electron-accepting compound may be contained in the undercoat layer as dispersed along with the inorganic particles therein, or may be contained in the layer as adhering to the surface of the inorganic particles.

As the method for adhering the electron-accepting compound to the inorganic particles, for example, there are mentioned a dry method or a wet method.

The dry method is, for example, a method where an electron-accepting compound is, either directly or as dissolved in an organic solvent, dropwise added to inorganic particles kept stirred with a mixer having a large shearing force or the like, or sprayed onto the particles along with dry air or nitrogen gas, to thereby make the electron-accepting compound adhere to the surface of the inorganic particles. After the electron-accepting compound is dropwise added to or sprayed onto the particles, the resultant particles may be further baked at 100° C. or higher. The baking is not specifically defined so far as the temperature and the time for the treatment could be enough to provide the necessary electrophotographic properties.

The wet method is, for example, a method where an electron-accepting compound is added to inorganic particles kept dispersed in a solvent by stirring or with ultrasonic waves or using a sand mill, an attritor, a ball mill or the like, and after the particles are thus stirred or dispersed, the solvent is removed to thereby make the electron-accepting compound adhere to the surface of the inorganic particles. As the solvent removing method, for example, the solvent is removed through filtration or vaporization. After the solvent removal, the particles may be further baked at 100° C. or higher. The baking is not specifically defined so far as the temperature and the time for the treatment could be enough to provide the necessary electrophotographic properties. In the wet method, water may be removed from the inorganic particles before an electron-accepting compound is added thereto, and examples of the case include a method of stirring the particles under heat in a solvent to remove water, and a method of azeotropic water removal with a solvent.

Adhering the electron-accepting compound to the inorganic particles may be carried out before surface treatment of the particles with a surface-treating agent, or adhering the electron-accepting compound thereto and surface treatment with a surface-treating agent may be carried out simultaneously.

The content of the electron-accepting compound is, for example, preferably from 0.01% by weight to 20% by weight relative to the inorganic particles, more preferably from 0.01% by weight to 10% by weight.

The binder resin for use in the undercoat layer includes, for example, known polymer compounds such as acetal resins (for example, polyvinyl butyral, and the like), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyl resins, urea resins, phenol resins, phenol-formaldehyde resins, melamine resins, urethane resins, alkyd resins, epoxy resins, and the like; zirconium chelate compounds; titanium chelate compounds; aluminum chelate compounds; titanium alkoxide compounds; organic titanium compounds; silane coupling agents, and the like.

As the binder resin for use in the undercoat layer, for example, also mentioned are charge-transporting resins having a charge-transporting group, conductive resins (for example, polyaniline, and the like), and the like.

Of those, as the binder resin for use in the undercoat layer, preferred are resins insoluble in the coating solvent in the upper layer, and especially preferred are thermosetting resins such as urea resins, phenol resins, phenol-formaldehyde resins, melamine resins, urethane resins, unsaturated polyester resins, alkyd resins, epoxy resins; and resins that are obtained through reaction of at least one resin selected from a group consisting of polyamide resins, polyester resin, polyether resins, methacrylic resins, acrylic resins, polyvinyl alcohol resins and polyvinyl acetal resins, and a curing agent.

In case where two or more of those binder resins are used here as combined, the blending ratio thereof may be suitably defined as needed.

The undercoat layer may contain various additives for improving the electric properties and the environmental stability thereof and for image enhancement.

As the additives, usable here are known materials such as polycyclic condensed or azo-type electron-transporting pigments, zirconium chelate compounds, titanium chelate compounds, aluminum chelate compounds, titanium alkoxide compounds, organic titanium compounds, silane coupling agents, and the like. A silane coupling agent may be used for surface treatment of inorganic particles as mentioned above, but may be added to the undercoat layer as an additive therein.

The silane coupling agents as an additive include, for example, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, 3-chloropropyltrimethoxysilane, and the like.

The zirconium chelate compounds include, for example, zirconium butoxide, zirconium ethylacetacetate, zirconium triethanolamine, acetylacetonate zirconium butoxide, ethyl acetacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, isostearate zirconium butoxide, and the like.

The titanium chelate compounds include, for example tetraisopropyl titanate, tetra-normal-butyl titanate, butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanolaminate, polyhydroxytitanium stearate, and the like.

The aluminum chelate compounds include, for example, aluminum isopropylate, monobutoxyaluminum diisopropylate, aluminum butyrate, diethyl acetate aluminum diisopropylate, aluminum tris(ethylacetacetate), and the like.

As these additives, alone or a mixture of plural compounds or a polycondensate thereof may be used here.

Preferably, the undercoat layer has a Vickers hardness of 35 or more.

Preferably, the surface roughness (ten-point mean roughness) of the undercoat layer is so controlled as to fall within a range of from ¼n (n is the refractive index of the upper layer) of the wavelength λ of the laser for exposure to ½λ for preventing moire patterns.

Resin particles or the like may be added to the undercoat layer for controlling the surface roughness thereof. The resin particles include silicone resin particles, crosslinked polymethyl methacrylate resin particles, or the like. For controlling the surface roughness thereof, the surface of the undercoat layer may be polished. The polishing method includes, for example buff polishing, sand blast polishing, wet honing, grinding treatment, and the like.

Not specifically defined, any known method is employable for forming the undercoat layer. For example, a coating film of an undercoat layer-forming coating liquid prepared by adding the above-mentioned components to a solvent is formed, and the coating film is dried and then optionally heated to form the undercoat layer.

The solvent in preparing the undercoat layer-forming coating liquid may be any known organic solvent, including, for example, alcohol solvents, aromatic hydrocarbon solvents, halogenohydrocarbon solvents, ketone solvents, ketone-alcohol solvents, ether solvents, ester solvents, and the like.

Concretely as those solvents, for example, there are mentioned ordinary organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, toluene.

As the method for dispersion of inorganic particles in preparing the undercoat layer-forming coating liquid, for example, there may be mentioned a known method using a roll mill, a ball mill, a shaking ball mill, an attritor, a sand mill, a colloid mill, a paint shaker, or the like.

The method of applying the undercoat layer-forming coating liquid onto a conductive substrate may be any ordinary method such as, for example, a blade coating method, a wire bar coating method, a spray coating method, a dip coating method, a bead coating method, an air knife coating method a curtain coating method.

The thickness of the undercoat layer is, for example, preferably defined within a range of 15 μm or more, more preferably 18 μm or more and 50 μm or less.

### (Interlayer)

Not shown in the drawing, an interlayer may be further arranged between the undercoat layer and the photosensitive layer.

The interlayer is, for example, a layer containing a resin. The resin for use in the interlayer includes, for example, polymer compounds such as acetal resins (for example, polyvinyl butyral, and the like), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyl resins, phenol-formaldehyde resins, melamine resins.

The interlayer may be a layer containing an organic metal compound. The organic metal compound for use in the interlayer is, for example, an organic metal compound containing a metal atom of zirconium, titanium, aluminum, manganese, silicone, or the like.

As the compound for use in the interlayer, one alone or a mixture of plural compounds or a polycondensate thereof may be used.

Of those, the interlayer is preferably a layer containing an organic metal compound that contains a zirconium atom or a silicon atom.

Not specifically defined, the interlayer may be formed according to any known method. For example, a coating film of an interlayer-forming coating liquid prepared by adding the above-mentioned components in a solvent is formed, and the coating film is dried and optionally heated to form the interlayer.

As the coating method for forming the interlayer, employable here is any known method such as a dip coating method, a toss coating method, a wire bar coating method, a spray coating method, a blade coating method, a knife coating method, a curtain coating method.

The thickness of the interlayer is, for example, preferably defined within a range from 0.1 μm to 3 μm. The interlayer may serve also as the undercoat layer.

### (Charge Generation Layer)

The charge generation layer is, for example, a layer containing a charge-generating material and a binder resin. The charge generation layer may also be a layer formed through vapor deposition of a charge-generating material. The vapor-deposited layer of a charge-generating material is favorable in a case of using a non-interference light source such as an LED (light emitting diode), an organic EL (electroluminescent) image array.

The charge-generating material includes azo pigments such as bisazo pigments, trisazo pigments; condensed-ring aromatic pigments such as dibromoanthanthrone; perylene pigments; pyrrolopyrrole pigments; phthalocyanine pigments; zinc oxide; trigonal selenium, and the like.

Of those, as the charge-generating material, preferred is use of a metal phthalocyanine pigment or a non-metal phthalocyanine pigment for applicability to near-IR laser exposure. Concretely, for example, more preferred are hydroxygallium phthalocyanine; chlorogallium phthalocyanine; dichlorotin phthalocyanine; titanylphthalocyanine.

On the other hand, as the charge-generating material, preferred is use of condensed-ring aromatic pigments such as dibromoanthanthrone; thioindigo pigments; porphyrazine compounds; zinc oxide; trigonal selenium; bisazo pigments, for applicability to near-UV laser exposure.

In a case of using a non-interference light source such as an LED having an emission center wavelength in a range of from 450 nm to 780 nm, an organic EL image array or the like, the above-mentioned charge-generating material may also be used, but from the viewpoint of resolution, in a case where the photosensitive layer is a thin film having a thickness of 20 μm or less, the electric field intensity in the photosensitive layer increases, therefore often causing charge reduction therein owing to charge injection from the substrate thereby to provide image defects that are generally referred to as black spots. This is remarkable when a charge-generating material of a p-type semiconductor that readily generate a dark current, such as trigonal selenium, a phthalocyanine pigment or the like, is used.

As opposed to this, in a case where an n-type semiconductor such as a condensed-ring aromatic pigment, a perylene pigment, an azo pigment or the like is used as a charge-generating material, a dark current would hardly form, and in the case, even though thin, the layer can still prevent image defects referred to as black spots.

The type of semiconductors as to whether they are n-type ones may be determined based on the polarity of the photocurrent running therethrough, according to an ordinary time-of-flight method, in which those where electrons are the majority carriers while holes are minority carriers are determined to be n-type semiconductors.

Among the above, the charge-generating material is preferably a hydroxygallium phthalocyanine pigment from the viewpoint of the charge generation efficiency thereof, and is more preferably a V-type hydroxygallium phthalocyanine pigment.

In particular, as the hydroxygallium phthalocyanine pigment, for example, more preferred is a hydroxygallium phthalocyanine pigment having, in absorption spectrum thereof in a wavelength range of from 600 nm to 900 nm, a maximum peak wavelength in a range of from 810 nm to 830 nm, from the viewpoint of having more excellent dispersibility.

In addition, the above-mentioned hydroxygallium phthalocyanine pigment having a maximum peak wavelength in a range of from 810 nm to 830 nm is preferably one having a mean particle size that falls within a specific range and having a BET specific surface area that falls within a specific range. Concretely, it is desirable that the mean particle size of the pigment is 0.20 μm or less, and is more preferably within a range of from 0.01 μm to 0.15 nm. On the other hand, the BET specific surface area of the pigment is preferably 45 m²/g or more, more preferably 50 m²/g, and is even more preferably within a range of from 55 m²/g to 120 m²/g. The mean particle size is a volume-average particle size (d50 mean particle size) measured with a laser diffraction scattering particle sizer (LA-700, by Horiba Ltd.). The BET specific surface area is one measured with a BET specific surface area measuring instrument (Shimadzu's Flow Sorb II2300) according to a nitrogen substitution method.

The maximum particle size (the maximum value of the primary particle size) of the hydroxygallium phthalocyanine pigment is preferably 1.2 μm or less, more preferably 1.0 μm or less, even more preferably 0.3 μm or less.

Preferably, the mean particle size of the hydroxygallium phthalocyanine pigment is 0.2 μm or less, the maximum particle size thereof is 1.2 μm or less, and the specific surface area thereof is 45 m²/g or more.

Preferably, the hydroxygallium phthalocyanine pigment is a V-type one having, in the X-ray diffraction spectrum thereof using a CuKα characteristic X ray, diffraction peaks at the Bragg angle (2θ±0.2°) of at least 7.3°, 16.0°, 24.9° and 28.0°.

One alone or two or more different types of charge-generating materials may be used here either singly or as combined.

The binder resin for use in the charge generation layer may be selected from a wide range of insulating resins, and the binder resin may be selected from organic photoconductive polymers such as poly-N-vinylcarbazole polyvinylanthracene, polyvinylpyrene, polysilane.

The binder resin includes, for example, polyvinyl butyral resins, polyarylate resins (polycondensates of bisphenols and aromatic dicarboxylic acids, or the like), polycarbonate resins, polyester resins, phenoxy resins, vinyl chloride-vinyl acetate copolymers, polyamide resins, acrylic resins, polyacrylamide resins, polyvinylpyridine resins, cellulose resins, urethane resins, epoxy resins, casein, polyvinyl alcohol resins, polyvinylpyrrolidone resins, and the like. Here, “insulating” means that the volume resistivity of the resin is 10¹³ Ωcm or more.

One alone or two or more different types of those binder resins may be used here either singly or as combined.

The blend ratio of the charge-generating material and the binder resin is, as a ratio thereof by weight, preferably within a range of from 10/1 to 1/10.

In addition, the charge generation layer may contain any other known additive.

Not specifically defined, any known formation method is employable for forming the charge generation layer. For example, a coating film of a charge generation layer-forming coating liquid that contains the above-mentioned components added to a solvent is formed, the coating film is dried and optionally heated to form the layer. The charge generation layer may also be formed through vapor deposition with a charge-generating material. Formation of the charge generation layer through vapor deposition is favorable especially in a case of using a condensed-ring aromatic pigment or a perylene pigment as a charge-generating material.

The solvent for use in preparing the charge generation layer-forming coating liquid includes methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, toluene, and the like. One alone or two or more these solvents may be used here either singly or as combined.

For the method of dispersing particles (of, for example, a charge-generating material) in the charge generation layer-forming coating liquid, for example, usable is a media disperser such as a ball mill, a shaking ball mill, an attritor, a sand mill, a horizontal sand mill, and the like, or a medialess disperser such as a stirrer, an ultrasonic disperser, a roll mill, a high-pressure homogenizer. For the high-pressure homogenizer, for example, there are mentioned a collision system where a dispersion under a high pressure condition is dispersed through liquid-liquid collision or liquid-wall collision, and a penetration system for dispersion by penetration through a fine flow channel under a high pressure condition.

In dispersion, it is desirable that the mean particle size of the charge-generating material in the charge generation layer-forming coating liquid is 0.5 μm or less, more preferably 0.3 μm or less, even more preferably 0.15 μm or less.

As the method of applying the charge generation layer-forming coating liquid onto the undercoat layer (or onto the interlayer), for example, there are mentioned ordinary methods such as a blade coating method, a wire bar coating method, a spray coating method, a dip coating method, a bead coating method, an air knife coating method, a curtain coating method.

The thickness of the charge generation layer is defined, for example, to fall preferably within a range of from 0.1 μm to 5.0 μm, more preferably from 0.2 μm to 2.0 μm.

### (Charge Transport Layer)

The charge transport layer is, for example, a layer containing a charge-transporting material and a binder resin.

As the charge-transporting material, the layer contains the butadiene charge-transporting material (CT1) and the benzidine charge-transporting material (CT2). The layer that contains the butadiene charge-transporting material (CT1) and the benzidine charge-transporting material (CT2) further contains at least one selected from a group consisting of a hindered phenol antioxidant and a benzophenone UV absorbent.

Further, the charge transport material may contain a BP polycarbonate resin, or a fluorine-containing resin particles and a fluorine-containing dispersant.

### —Charge-Transporting Material—

The butadiene charge-transporting material (CT1) is described.

The butadiene charge-transporting material (CT1) is a charge-transporting material represented by the following general formula (CT1).

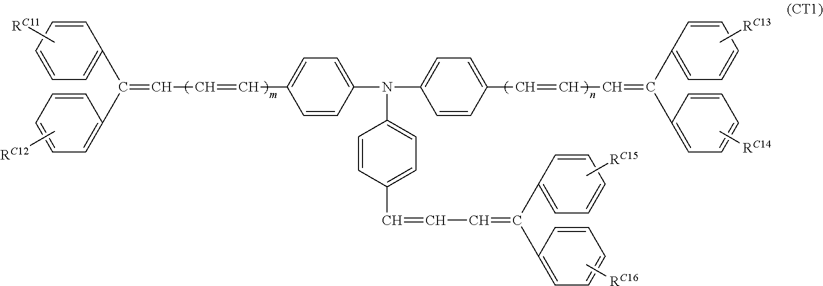

In the general formula (CT1), R^{C11}, R^{C12}, R^{C13}, R^{C14}, R^{C15} and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, and the adjacent two substituents may bond to each other to form a hydrocarbon-cyclic structure.

n and m each independently indicate 0, 1 or 2.

In the general formula (CT1), the halogen atom represented by R^{C11}, R^{C12}, R^{C13}, R^{C14}, R^{C15} and R^{C16} includes a fluorine atom, a chlorine atom, a bromine atom, an iodine atom, or the like. Of those, as the halogen atom, preferred are a fluorine atom and a chlorine atom, and more preferred is a chlorine atom.

In the general formula (CT1), the alkyl group represented by R^{C11}, R^{C12}, R^{C13}, R^{C14}, R^{C15} and R^{C16} includes a linear or branched alkyl group having from 1 to 20 carbon atoms (preferably from 1 to 6 carbon atoms, more preferably from 1 to 4 carbon atoms).

The linear alkyl group includes concretely a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosyl group, and the like.

The branched alkyl group includes concretely an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isoundecyl group, a sec-undecyl group, a tert-undecyl group, a neoundecyl group, an isododecyl group, a sec-dodecyl group, a tert-dodecyl group, a neododecyl group, an isotridecyl group, a sec-tridecyl group, a tert-tridecyl group, a neotridecyl group, an isotetradecyl group, a sec-tetradecyl group, a tert-tetradecyl group, a neotetradecyl group, a 1-isobutyl-4-ethyloctyl group, an isopentadecyl group, a sec-pentadecyl group, a tert-pentadecyl group, a neopentadecyl group, an isohexadecyl group, a sec-hexadecyl group, a tert-hexadecyl group, a neohexadecyl group, a 1-methylpentadecyl group, an isoheptadecyl group, a sec-heptadecyl group, a tert-heptadecyl group, a neoheptadecyl group, an isooctadecyl group, a sec-octadecyl group, a tert-octadecyl group, a neooctadecyl group, an isononadecyl group, a sec-nonadecyl group, a tert-nonadecyl group, a neononadecyl group, a 1-methyloctyl group, an isoeicosyl group, a sec-eicosyl group, a tert-eicosyl group, a neoeicosyl group, and the like.

Of those, as the alkyl group, preferred is a lower alkyl group such as a methyl group, an ethyl group, an isopropyl group.

In the general formula (CT1), the alkoxy group represented by R^{C11}, R^{C12}, R^{C13}, R^{C14}, R^{C15} and R^{C16} includes a linear or branched alkoxy group having from 1 to 20 carbon atoms (preferably from 1 to 6 carbon atoms, more preferably from 1 to 4 carbon atoms).

The linear alkoxy group includes concretely a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-pentadecyloxy group, an n-hexadecyloxy group, an n-heptadecyloxy group, an n-octadecyloxy group, an n-nonadecyloxy group, an n-eicosyloxy group, and the like.

The branched alkoxy group includes concretely an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, a tert-decyloxy group, an isoundecyloxy group, a sec-undecyloxy group, a tert-undecyloxy group, a neoundecyloxy group, an isododecyloxy group, a sec-dodecyloxy group, a tert-dodecyloxy group, a neododecyloxy group, an isotridecyloxy group, a sec-tridecyloxy group, a tert-tridecyloxy group, a neotridecyloxy group, an isotetradecyloxy group, a sec-tetradecyloxy group, a tert-tetradecyloxy group, a neotetradecyloxy group, a 1-isobutyl-4-ethyloctyloxy group, an isopentadecyloxy group, a sec-pentadecyloxy group, a tert-pentadecyloxy group, a neopentadecyloxy group, an isohexadecyloxy group, a sec-hexadecyloxy group, a tert-hexadecyloxy group a neohexadecyloxy group, a 1-methylpentadecyloxy group, an isoheptadecyloxy group, a sec-heptadecyloxy group, a tert-heptadecyloxy group, a neoheptadecyloxy group, an isooctadecyloxy group, a sec-octadecyloxy group, a tert-octadecyloxy group, a neooctadecyloxy group, an isononadecyloxy group, a sec-nonadecyloxy group, a tert-nonadecyloxy group, a neononadecyloxy group, a 1-methyloctyloxy group, an isoeicosyloxy group, a sec-eicosyloxy group, a tert-eicosyloxy group, a neoeicosyloxy group, and the like.

Of those, as the alkoxy group, preferred is a methoxy group.

In the general formula (CT1), the aryl group represented by R^{C11}, R^{C12}, R^{C13}, R^{C14}, R^{C15} and R^{C16} includes an aryl group having from 6 to 30 carbon atoms (preferably from 6 to 20 carbon atoms, more preferably from 6 to 16 carbon atoms).

The aryl group concretely includes a phenyl group, a naphthyl group, a phenanthryl group, a biphenyl group, and the like.

Of those, as the aryl group, preferred are a phenyl group and a naphthyl group.

In the general formula (CT1), the above-mentioned substituents represented by R^{C11}, R^{C12}, R^{C13}, R^{C14}, R^{C15} and R^{C16} include those further having a substituent. The additional substituent for those substituents includes the atoms and the groups (for example, halogen atom, alkyl group, alkoxy group, aryl group, and the like) exemplified hereinabove.

In the general formula (CT1), in the hydrocarbon-cyclic structure to be formed by the two adjacent substituents of R^{C11}, R^{C12}, R^{C13}, R^{C14}, R^{C15} and R^{C16} bonding to each other (for example, R^{C11} and R^{C12}, R^{C13} and R^{C14}, or R^{C15} and R^{C16}), the linking group to link the two adjacent substituents includes a single bond, a 2,2′-methylene group, a 2,2′-ethylene group, a 2,2′-vinylene group, or the like. Of those, preferred are a single bond and a 2,2′-methylene group.

Here, concretely, the hydrocarbon-cyclic structure includes, for example, a cycloalkane structure, a cycloalkene structure, a cycloalkane-polyene structure, and the like.

In the general formula (CT1), n and m are preferably 1.

In the general formula (CT1), preferably, R^{C11}, R^{C12}, R^{C13}, R^{C14}, R^{C15} and R^{C16} each are a hydrogen atom, an alkyl group having from 1 to 20 carbon atoms, or an alkoxy group having from 1 to 20 carbon atoms, and m and n each are 1 or 2, from the viewpoint of forming a photosensitive layer (charge transport layer) having high charge transportability, and more preferably, R^{C11}, R^{C12}, R^{C13}, R^{C14}, R^{C15} and R^{C16} are hydrogen atoms and m and n are 1.

In other words, the butadiene charge-transporting material (CT1) is more preferably a charge-transporting material represented by the following structural formula (CT1A) (exemplified compound (CT1-3)).

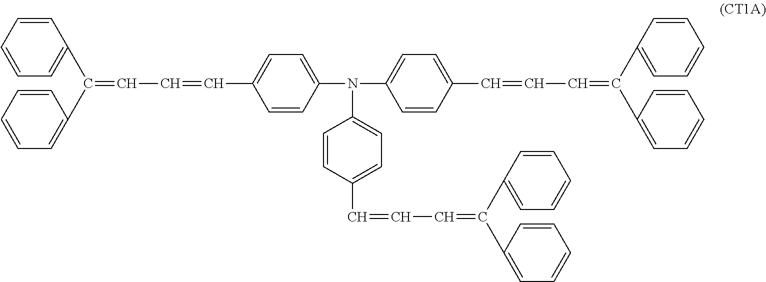 [SMILES: C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

Specific examples of the butadiene charge-generating material (CT1) are shown below, to which, however, the present invention is not limited.

| Exem- | | | | | | | | |
|---|---|---|---|---|---|---|---|---|
| plified | | | | | | | | |
| Com- | | | | | | | | |
| pounds | | | | | | | | |
| No. | m | n | R^{C11} | R^{C12} | R^{C13} | R^{C14} | R^{C15} | R^{C16} |
| CT1-1 | 1 | 1 | 4-CH₃ | 4-CH₃ | 4-CH₃ | 4-CH₃ | H | H |
| CT1-2 | 2 | 2 | H | H | H | H | 4-CH₃ | 4-CH₃ |
| CT1-3 | 1 | 1 | H | H | H | H | H | H |
| CT1-4 | 2 | 2 | H | H | H | H | H | H |
| CT1-5 | 1 | 1 | 4-CH₃ | 4-CH₃ | 4-CH₃ | H | H | H |
| CT1-6 | 0 | 1 | H | H | H | H | H | H |
| CT1-7 | 0 | 1 | 4-CH₃ | 4-CH₃ | 4-CH₃ | 4-CH₃ | 4-CH₃ | 4-CH₃ |
| CT1-8 | 0 | 1 | 4-CH₃ | 4-CH₃ | H | H | 4-CH₃ | 4-CH₃ |
| CT1-9 | 0 | 1 | H | H | 4-CH₃ | 4-CH₃ | H | H |
| CT1-10 | 0 | 1 | H | H | 4-CH₃ | 4-CH₃ | H | H |
| CT1-11 | 0 | 1 | 4-CH₃ | H | H | H | 4-CH₃ | H |
| CT1-12 | 0 | 1 | 4-OCH₃ | H | H | H | 4-OCH₃ | H |
| CT1-13 | 0 | 1 | H | H | 4-OCH₃ | 4-OCH₃ | H | H |
| CT1-14 | 0 | 1 | 4-OCH₃ | H | 4-OCH₃ | H | 4-OCH₃ | 4-OCH₃ |
| CT1-15 | 0 | 1 | 3-CH₃ | H | 3-CH₃ | H | 3-CH₃ | H |
| CT1-16 | 1 | 1 | 4-CH₃ | 4-CH₃ | 4-CH₃ | 4-CH₃ | 4-CH₃ | 4-CH₃ |
| CT1-17 | 1 | 1 | 4-CH₃ | 4-CH₃ | H | H | 4-CH₃ | 4-CH₃ |
| CT1-18 | 1 | 1 | H | H | 4-CH₃ | 4-CH₃ | H | H |
| CT1-19 | 1 | 1 | H | H | 3-CH₃ | 3-CH₃ | H | H |
| CT1-20 | 1 | 1 | 4-CH₃ | H | H | H | 4-CH₃ | H |
| CT1-21 | 1 | 1 | 4-OCH₃ | H | H | H | 4-OCH₃ | H |
| CT1-22 | 1 | 1 | H | H | 4-OCH₃ | 4-OCH₃ | H | H |
| CT1-23 | 1 | 1 | 4-OCH₃ | H | 4-OCH₃ | H | 4-OCH₃ | 4-OCH₃ |
| CT1-24 | 1 | 1 | 3-CH₃ | H | 3-CH₃ | H | 3-CH₃ | H |

Abbreviations in the exemplified compounds shown above have the following meanings. The number given before each substituent indicates the substitution position of the substituent relative to the benzene ring.

—CH₃: methyl group

—OCH₃: methoxy group

One alone or two or more butadiene charge-transporting materials (CT1) may be used here either singly or as combined.

The benzidine charge-transporting material (CT2) is described below.

The benzidine charge-transporting material (CT2) is a charge-transporting material represented by the following general formula (CT2).

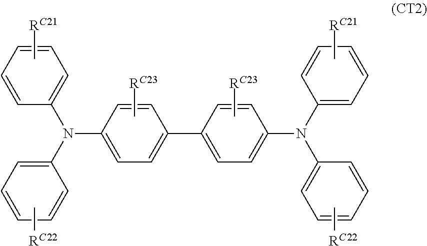

In the general formula (CT2), R^{C21}, R^{C22} and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

In the general formula (CT2), the halogen atom represented by R^{C21}, R^{C22} and R^{C23} includes a fluorine atom, a chlorine atom, a bromine atom, an iodine atom, and the like. Of those, as the halogen atom, preferred are a fluorine atom and a chlorine atom, and more preferred is a chlorine atom.

In the general formula (CT2), the alkyl group represented by R^{C21}, R^{C22} and R^{C23} includes a linear or branched alkyl group having from 1 to 10 carbon atoms (preferably from 1 to 6 carbon atoms, more preferably from 1 to 4 carbon atoms).

The linear alkyl group includes concretely a methyl group, an ethyl group, an n-propyl group, an n-butyl group, an n-pentyl group, an n-hexyl group, an n-heptyl group, an n-octyl group, an n-nonyl group, an n-decyl group, and the like.

The branched alkyl group includes concretely an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, and the like.

Of those, as the alkyl group, preferred is a lower alkyl group such as a methyl group, an ethyl group, an isopropyl group, or the like.

In the general formula (CT2), the alkoxy group represented by R^{C21}, R^{C22} and R^{C23} includes a linear or branched alkoxy group having from 1 to 10 carbon atoms (preferably from 1 to 6 carbon atoms, more preferably from 1 to 4 carbon atoms).

The linear alkoxy group includes concretely a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, and the like.

The branched alkoxy group includes concretely an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, a tert-decyloxy group, and the like.

Of those, as the alkoxy group, preferred is a methoxy group.

In the general formula (CT2), the aryl group represented by R^{C21}, R^{C22} and R^{C23} includes an aryl group having from 6 to 10 carbon atoms (preferably from 6 to 9 carbon atoms, more preferably from 6 to 8 carbon atoms).

The aryl group concretely includes a phenyl group, a naphthyl group, and the like.

Of those, as the aryl group, preferred is a phenyl group.

In the general formula (CT2), the above-mentioned substituents represented by R^{C21}, R^{C22} and R^{C23} include those further having a substituent. The additional substituent for those substituents includes the atoms and the groups (for example, halogen atom, alkyl group, alkoxy group, aryl group, or the like) exemplified hereinabove.

In the general formula (CT2), preferably, R^{C21}, R^{C22} and R^{C23} each are independently a hydrogen atom, or an alkyl group having from 1 to 10 carbon atoms, from the viewpoint of forming a photosensitive layer (charge transport layer) having high charge transportability, and more preferably, R^{C21} and R^{C23} are hydrogen atom, and R^{C22} is an alkyl group having from 1 to 10 carbon atoms (especially a methyl group).

Concretely, the benzidine charge-transporting material (CT2) is especially preferably a charge-transporting material represented by the following structural formula (CT2A) (exemplified compound (CT2-2)).

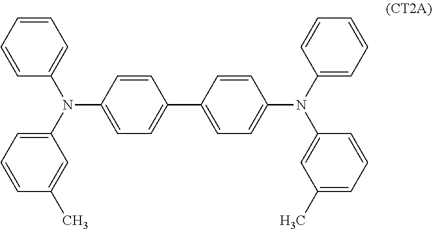 [SMILES: Cc1cccc(N(c2ccccc2)c2ccc(-c3ccc(N(c4ccccc4)c4cccc(C)c4)cc3)cc2)c1]

Specific Examples of the benzidine charge-transporting material (CT2) are shown below, to which, however, the present invention is not limited.

| Exemplified | | | |
|---|---|---|---|
| Compounds No. | R^{C21} | R^{C22} | R^{C23} |
| CT2-1 | H | H | H |
| CT2-2 | H | 3-CH₃ | H |
| CT2-3 | H | 4-CH₃ | H |
| CT2-4 | H | 3-C₂H₅ | H |
| CT2-5 | H | 4-C₂H₅ | H |
| CT2-6 | H | 3-OCH₃ | H |
| CT2-7 | H | 4-OCH₃ | H |
| CT2-8 | H | 3-OC₂H₅ | H |
| CT2-9 | H | 4-OC₂H₅ | H |
| CT2-10 | 3-CH₃ | 3-CH₃ | H |
| CT2-11 | 4-CH₃ | 4-CH₃ | H |
| CT2-12 | 3-C₂H₅ | 3-C₂H₅ | H |
| CT2-13 | 4-C₂H₅ | 4-C₂H₅ | H |
| CT2-14 | H | H | 2-CH₃ |
| CT2-15 | H | H | 3-CH₃ |
| CT2-16 | H | 3-CH₃ | 2-CH₃ |
| CT2-17 | H | 3-CH₃ | 3-CH₃ |
| CT2-18 | H | 4-CH₃ | 2-CH₃ |
| CT2-19 | H | 4-CH₃ | 3-CH₃ |
| CT2-20 | 3-CH₃ | 3-CH₃ | 2-CH₃ |
| CT2-21 | 3-CH₃ | 3-CH₃ | 3-CH₃ |
| CT2-22 | 4-CH₃ | 4-CH₃ | 2-CH₃ |
| CT2-23 | 4-CH₃ | 4-CH₃ | 3-CH₃ |

Abbreviations in the exemplified compounds shown above have the following meanings. The number given before each substituent indicates the substitution position of the substituent relative to the benzene ring.

—CH₃: methyl group

—C₂H₅: ethyl group

—OCH₃: methoxy group

—OC₂H₅: ethoxy group

One alone or two or more benzidine charge-transporting materials (CT2) may be used here either singly or as combined.

The hindered phenol antioxidant is described below.

The hindered phenol antioxidant is a compound having a hindered phenol ring and having a molecular weight of 300 or more.

In the hindered phenol antioxidant, the hindered phenol ring is, for example, a phenol ring substituted with at least one alkyl group having from 4 to 8 carbon atoms (for example, a branched alkyl group having from 4 to 8 carbon atoms). More concretely, the hindered phenol ring is, for example, a phenol ring substituted with a tertiary alkyl group (for example, a tert-butyl group) at the ortho-position relative to the phenolic hydroxyl group.

The hindered phenol antioxidant includes:

1) an antioxidant having one hindered phenol ring,

2) an antioxidant having from 2 to 4 hindered phenol rings, in which from 2 to 4 though hindered phenol rings are bonded to each other via a linking group that includes a linear or branched, divalent to tetravalent aliphatic hydrocarbon group, or via a linking group that includes at least one of an ester bond (—C(═O)O—) and an ether bond (—O—) existing between the carbon-carbon bond in a divalent to tetravalent aliphatic hydrocarbon group,

3) an antioxidant having from 2 to 4 hindered phenol rings and one benzene ring (unsubstituted or substituted with an alkyl group or the like) or isocyanurate ring, in which from 2 to 4 those hindered phenol rings each are bonded to the benzene ring or the isocyanurate ring via an alkylene group.

Concretely, the hindered phenol antioxidant is preferably an antioxidant represented by the following general formula (HP) from the viewpoint of preventing burn-in ghosting and optical fatigue in the photoreceptor.

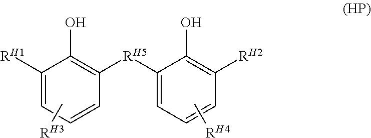

In the general formula (HP), R^{H1} and R^{H2} each independently represent a branched alkyl group having from 4 to 8 carbon atoms.

R^{H3} and R^{H4} each independently represent a hydrogen atom, or an alkyl group having from 1 to 10 carbon atoms.

R^{H5} represents an alkylene group having from 1 to 10 carbon atoms.

In the general formula (HP), the alkyl group represented by R^{H1} and R^{H2} includes a branched alkyl group having from 4 to 8 carbon atoms (preferably from 4 to 6 carbon atoms).

The branched alkyl group includes concretely an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, and the like.

Of those, as the alkyl group, preferred are a tert-butyl group and a tert-pentyl group, and more preferred is a tert-butyl group.

In the general formula (HP), as R^{H3} and R^{H4}, there is mentioned a linear or branched alkyl group having from 1 to 10 carbon atoms (preferably from 1 to 4 carbon atoms).

The linear alkyl group includes concretely a methyl group, an ethyl group, an n-propyl group, an n-butyl group, an n-pentyl group, an n-hexyl group, an n-heptyl group, an n-octyl group, an n-nonyl group, an n-decyl group, and the like.

The branched alkyl group includes concretely an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, and the like.

Of those, as the alkyl group, preferred is a lower alkyl group such as a methyl group, an ethyl group.

In the general formula (HP), R^{H5} represents a linear or branched alkylene group having from 1 to 10 carbon atoms (preferably from 1 to 4 carbon atoms).

The linear alkylene group includes concretely a methylene group, an ethylene group, an n-propylene group, an n-butylene group, an n-pentylene group, an n-hexylene group, an n-heptylene group, an n-octylene group, an n-nonylene group, an n-decylene group, and the like.

The branched alkylene group includes concretely an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isobutylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, a tert-decylene group, and the like.

Of those, as the alkylene group, preferred is a lower alkylene group such as a methylene group, an ethylene group, a butylene group.

In the general formula (HP), the above-mentioned substituents represented by R^{H1}, R^{H2}, R^{H3}, R^{H4} and R^{H5} include those further having a substituent. The additional substituent for those substituents includes, for example, a halogen atom (for example, a fluorine atom, a chlorine atom), an alkoxy group (for example, an alkoxy group having from 1 to 4 carbon atoms), an aryl group (for example, a phenyl group, a naphthyl group) such as those mentioned hereinabove.

In the general formula (HP), in particular. R^{H1} and R^{H2} each are preferably a tert-butyl group from the viewpoint of preventing burn-in ghosting and optical fatigue in the photoreceptor. More preferably, R^{H1} and R^{H2} each are a tert-butyl group, R^{H3} and R^{H4} each are an alkyl group having from 1 to 3 carbon atoms (especially a methyl group), and R^{H5} is an alkylene group having from 1 to 4 carbon atoms (especially a methylene group).

Concretely, the hindered phenol antioxidant is especially preferably the exemplified compound (HP-3).

The molecular weight of the hindered phenol antioxidant is preferably from 300 to 1000, more preferably from 300 to 900, even more preferably from 300 to 800, from the viewpoint of preventing burn-in ghosting and optical fatigue in the photoreceptor.

Specific examples of the hindered phenol antioxidant are shown below, to which, however, the present invention is not limited.

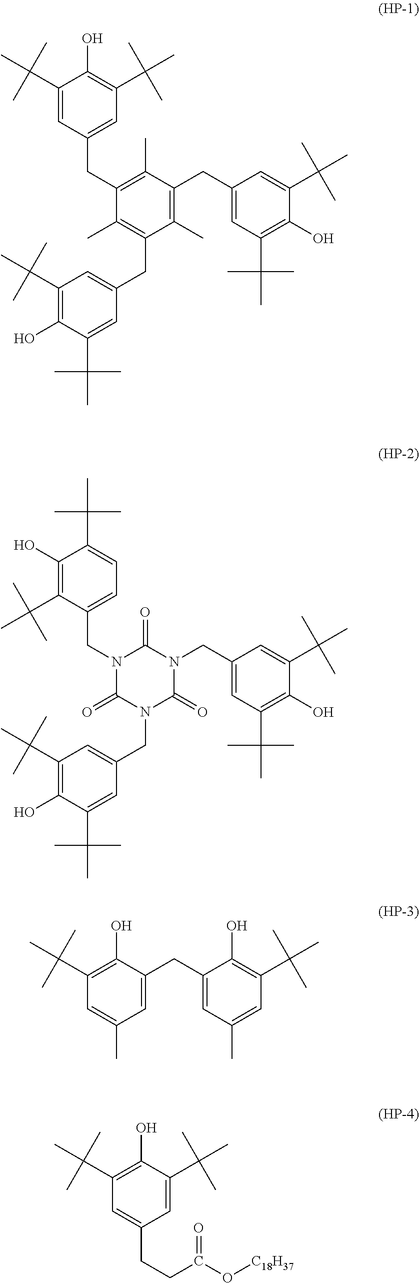

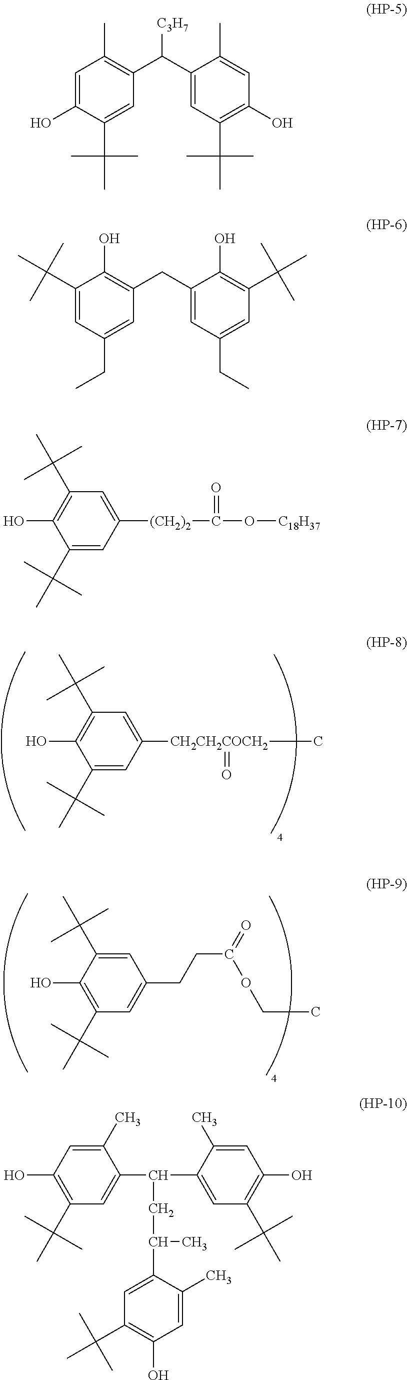

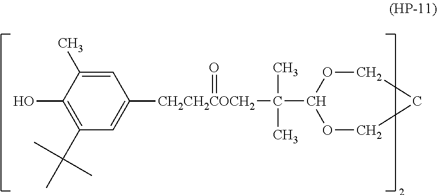

One alone or two or more hindered phenol antioxidants may be used here either singly or as combined.

Next described is the benzophenone UV absorbent.

The benzophenone UV absorbent is a compound having a benzophenone skeleton.

The benzophenone UV absorbents includes 1) a compound in which two benzene rings are unsubstituted, and 2) a compound in which two benzene rings each are independently substituted with at least one substituent selected from a group consisting of a hydroxyl group, a halogen atom, an alkyl group, an alkoxy group and an aryl group. In particular, the benzophenone UV absorbent is preferably a compound in which one of two benzene rings is at least substituted with a hydroxyl group (especially in the ortho-position relative to the group —C(═O)— therein).

Concretely, the benzophenone UV absorbent is preferably a UV absorbent represented by the following general formula (BP), from the viewpoint of preventing burn-in ghosting and optical fatigue in the photoreceptor.

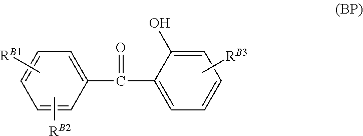

In the general formula (BP), R^{B1}, R^{B2} and R^{B3} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

In the general formula (BP), the halogen atom represented by R^{B1}, R^{B2} and R^{B3} includes a fluorine atom, a chlorine atom, a bromine atom, an iodine atom, and the like. Of those, as the halogen atom, preferred are a fluorine atom and a chlorine atom, and more preferred is a chlorine atom.

In the general formula (BP), the alkyl group represented by R^{B1}, R^{B2} and R^{B3} includes a linear or branched alkyl group having from 1 to 10 carbon atoms (preferably from 1 to 6 carbon atoms, more preferably from 1 to 4 carbon atoms).

The linear alkyl group includes concretely a methyl group, an ethyl group, an n-propyl group, an n-butyl group, an n-pentyl group, an n-hexyl group, an n-heptyl group, an n-octyl group, an n-nonyl group, an n-decyl group, and the like.

The branched alkyl group includes concretely an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, and the like.

Of those, as the alkyl group, preferred is a lower alkyl group such as a methyl group, an ethyl group, an isopropyl group, and the like.

In the general formula (BP), the alkoxy group represented by R^{B1}, R^{B2} and R^{B3} includes a linear or branched alkoxy group having from 1 to 10 carbon atoms (preferably from 1 to 6 carbon atoms, more preferably from 1 to 4 carbon atoms).

The linear alkoxy group includes concretely a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, and the like.

The branched alkoxy group includes concretely an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, a tert-decyloxy group, and the like.

Of those, as the alkoxy group, preferred is a methoxy group.

In the general formula (BP), the aryl group represented by R^{B1}, R^{B2} and R^{B3} includes an aryl group having from 6 to 10 carbon atoms (preferably from 6 to 9 carbon atoms, more preferably from 6 to 8 carbon atoms).

The aryl group concretely includes a phenyl group, a naphthyl group, and the like.

Of those, as the aryl group, preferred is a phenyl group.

In the general formula (BP), the above-mentioned substituents represented by R^{B1}, R^{B2} and R^{B3} include those further having a substituent. The additional substituent for those substituents includes the atoms and the groups (for example, halogen atom, alkyl group, alkoxy group, aryl group, and the like) exemplified hereinabove.

In the general formula (BP), especially preferably, R^{B1} and R^{B2} are hydrogen atoms and R^{B3} is an alkoxy group having from 1 to 3 carbon atoms from the viewpoint of preventing burn-in ghosting and optical fatigue in the photoreceptor.

Concretely, the UV absorbent is preferably a benzophenone UV absorbent represented by the following structural formula (BPA) (exemplified compound (BP-3)).

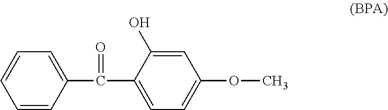 [SMILES: COc1ccc(C(=O)c2ccccc2)c(O)c1]

Specific examples of the benzophenone UV absorbent (benzophenone UV absorbent represented by the general formula (BP)) are shown below, to which, however, the present invention is not limited.

| Exemplified | | | |
|---|---|---|---|
| Compounds No. | R^{B1} | R^{B2} | R^{B3} |
| BP-1 | H | H | 4-OH |
| BP-2 | H | H | 4-(CH₂)₇—CH₃ |
| BP-3 | H | H | 4-OCH₃ |
| BP-4 | H | H | H |
| BP-5 | H | 3-CH₃ | 4-OH |
| BP-6 | H | 3-CH₃ | 4-(CH₂)₇—CH₃ |
| BP-7 | H | 3-CH₃ | 4-OCH₃ |
| BP-8 | H | 3-CH₃ | H |
| BP-9 | H | 4-CH₃ | 4-OH |
| BP-10 | H | 4-CH₃ | 4-(CH₂)₇—CH₃ |
| BP-11 | H | 4-CH₃ | 4-OCH₃ |
| BP-12 | H | 4-CH₃ | H |
| BP-13 | 2-CH₃ | 4-CH₃ | 4-OH |
| BP-14 | 2-CH₃ | 4-CH₃ | 4-(CH₂)₇—CH₃ |
| BP-15 | 2-CH₃ | 4-CH₃ | 4-OCH₃ |
| BP-16 | 2-CH₃ | 4-CH₃ | H |
| BP-17 | H | 3-C₂H₅ | 4-OH |
| BP-18 | H | 3-C₂H₅ | 4-(CH₂)₇—CH₃ |
| BP-19 | H | 3-C₂H₅ | 4-OCH₃ |
| BP-20 | H | 3-C₂H₅ | H |
| BP-21 | H | 4-C₂H₅ | 4-OH |
| BP-22 | H | 4-C₂H₅ | 4-(CH₂)₇—CH₃ |
| BP-23 | H | 4-C₂H₅ | 4-OCH₃ |
| BP-24 | H | 4-C₂H₅ | H |

Abbreviations in the exemplified compounds shown above have the following meanings. The number given before each substituent indicates the substitution position of the substituent relative to the benzene ring.

—CH₃: methyl group

—C₂H₅: ethyl group

—(CH₂)₇—CH₃: octyl group

—OCH₃: methoxy group

—OH: hydroxy group

One alone or two or more benzophenone UV absorbents may be used here either singly or as combined.

Next described is the content of the charge-transporting material, the antioxidant and the UV absorbent.

The content of the butadiene charge-transporting material (CT1) is preferably such that the blend ratio of CT1 and the binder resin (CT1/binder resin, by weight) falls within a range of from 0.1/9.9 to 4.0/6.0, more preferably from 0.4/9.6 to 3.5/6.5, even more preferably from 0.6/9.4 to 3.0/7.0, from the viewpoint of forming a photosensitive layer (charge transport layer) having high charge transportability.

The content of the benzidine charge-transporting material (CT2) is preferably such that the blend ratio of CT2 and the binder resin (CT2/binder resin, by weight) falls within a range of from 1/9 to 7/3, more preferably from 2/8 to 6/4, even more preferably from 2/8 to 4/6, from the viewpoint of forming a photosensitive layer (charge transport layer) having high charge transportability.

The ratio by weight of the content of the butadiene charge-transporting material (CT1) and the content of the benzidine charge-transporting material (CT2) (content of butadiene charge-transporting material (CT1)/content of benzidine charge-transporting material (CT2)) is preferably from 1/9 to 5/5, more preferably from 1/9 to 4/6, even more preferably from 1/9 to 3/7, from the viewpoint of forming a photosensitive layer (charge transport layer) having high charge transportability.

In particular, when the ratio by mass of the content of the butadiene charge-transporting material (CT1) and the content of the benzidine charge-transporting material (CT2) falls within the above-mentioned range, then burn-in ghosting and optical fatigue would readily occur; however, owing to the presence of at least one selected from the hindered phenol antioxidant and the benzophenone IN absorbent in the layer along with those materials therein, the layer could be free from the problem of burn-in ghosting and optical fatigue.

Here, the layer may contain any other charge-transporting material than the butadiene charge-transporting material (CT1) and the benzidine charge-transporting material (CT2) therein. In the case, however, the amount of the other charge-transporting material in all the charge-transporting materials in the layer is preferably 10% by weight or less, (more preferably 5% by weight or less).

The content of the hindered phenol antioxidant is preferably from 0.5% by weight to 30.0% by weight relative to 100% by weight of the amount of all the charge-generating materials in the layer, more preferably from 0.5% by weight to 15% by weight, even more preferably from 0.5 to 9.0% by weight, from the viewpoint of preventing burn-in ghosting and optical fatigue in the photoreceptor. Here, the content of the hindered phenol antioxidant indicates the number of parts (parts by weight) relative to 100 parts by weight of the amount of all the charge-generating materials in the layer.

The content of the benzophenone UV absorbent is preferably from 0.5% by weight to 30.0% by weight relative to 100% by weight of the amount of all the charge-generating materials in the layer, more preferably from 0.5% by weight to 15% by weight, even more preferably from 0.5 to 9.0% by weight, from the viewpoint of preventing burn-in ghosting and optical fatigue in the photoreceptor. Here, the content of the benzophenone UV absorbent indicates the number of parts (parts by weight) relative to 100 parts by weight of the amount of all the charge-generating materials in the layer.

When the content of the hindered phenol antioxidant and that of the benzophenone UV absorbent are controlled to be 30.0% by weight each, then the antioxidant and the UV absorbent are prevented from interfering with the charge transportability of the charge-transporting materials in the layer. In other words, in the case, formation of an electrostatic latent image on the surface of the photoreceptor through exposure to light can be prevented from being retarded and therefore an image having the intended density can be readily obtained.

The binder resin for use in the charge transport layer includes polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazoles, polysilanes, and the like. Of those, as the binder resin, preferred are polycarbonate resins or polyarylate resins, and as mentioned above, most preferred are polycarbonate resins. One alone or two or more of those binder resins may be used here either singly or as combined.

The blend ratio by weight of the charge-transporting material and the binder resin is preferably from 10/1 to 1/5.

The charge transport layer may contain any other known additive.

Next described are preferred binder resins for use herein.

The binder resin for use in the charge transport layer is preferably a BP polycarbonate resin. The BP polycarbonate resin is a biphenyl copolymer-type polycarbonate resin that contains a structural unit having a biphenyl skeleton.

The BP polycarbonate resin includes, for example, a biphenyl copolymer-type polycarbonate resin having a structural unit represented by the following general formula (PCA) as the structural unit having a biphenyl skeleton, and any other structural unit.

The other structural unit includes a structural unit having a bisphenol skeleton (for example, bisphenol A, bisphenol B, bisphenol BP, bisphenol C, bisphenol F, bisphenol Z, and the like), and the like.

The BP polycarbonate resin concretely includes, for example, a copolymer of a dihydroxybiphenyl compound and a dihydroxybisphenol compound. The copolymer may be obtained, for example, according to a method of polycondensation with a carbonate-forming compound such as phosgene or the like or transesterification with a bisaryl carbonate, using a dihydroxybiphenyl compound and a dihydroxybisphenol compound as the starting material.

The dihydroxybiphenyl compound is a biphenyl compound having a biphenyl skeleton in which the two benzene rings of the biphenyl skeleton both have one hydroxyl group each. The dihydroxybiphenyl compound includes, for example, 4,4′-dihydroxybiphenyl, 4,4′-dihydroxy-3,3′-dimethylbiphenyl, 4,4′-dihydroxy-2,2′-dimethylbiphenyl, 4,4′-dihydroxy-3,3′-dicyclohexylbiphenyl, 3,3′-difluoro-4,4′-dihydroxybiphenyl, 4,4′-dihydroxy-3,3′-diphenylbiphenyl, and the like.

One alone or two or more of those dihydroxybiphenyl compounds may be used here either singly or as combined.

The dihydroxybisphenol compound is a bisphenol compound having a bisphenol skeleton in which the two benzene rings of the biphenyl skeleton both have one hydroxyl group each. The dihydroxybisphenol compound includes, for example, bis(4-hydroxyphenyl)methane, 1,1-bis(4-hydroxyphenyl)ethane, 1,2-bis(4-hydroxyphenyl)ethane, 2,2-bis(4-hydroxyphenyl)propane, 2,2-bis(3-methyl-4-hydroxyphenyl)butane, 2,2-bis(4-hydroxyphenyl)butane, 2,2-bis(4-hydroxyphenyl)octane, 4,4-bis(4-hydroxyphenyl)heptane, 1,1-bis(4-hydroxyphenyl)-1,1-diphenylmethane, 1,1-bis(4-hydroxyphenyl)-1-phenylethane, 1,1-bis(4-hydroxyphenyl)-1-phenylmethane, bis(4-hydroxyphenyl) ether, bis(4-hydroxyphenyl) sulfide, bis(4-hydroxyphenyl) sulfone, 1,1-bis(4-hydroxyphenyl)cyclopentane, 1,1-bis(4-hydroxyphenyl)cyclohexane, 2,2-bis(3-methyl-4-hydroxyphenyl)propane, 2-(3-methyl-4-hydroxyphenyl)-2-(4-hydroxyphenyl)-1-phenylethane, bis(3-methyl-4-hydroxyphenyl) sulfide, bis(3-methyl-4-hydroxyphenyl) sulfone, bis(3-methyl-4-hydroxyphenyl)methane, 1,1-bis(3-methyl-4-hydroxyphenyl)cyclohexane, 2,2-bis(2-methyl-4-hydroxyphenyl)propane, 1,1-bis(2-butyl-4-hydroxy-5-methylphenyl)butane, 1,1-bis(2-tert-butyl-4-hydroxy-3-methylphenyl)ethane, 1,1-bis(2-tert-butyl-4-hydroxy-5-methylphenyl)propane, 1,1-bis(2-tert-butyl-4-hydroxy-5-methylphenyl)butane, 1,1-bis(2-tert-butyl-4-hydroxy-5-methylphenyl)isobutane, 1,1-bis(2-tert-butyl-4-hydroxy-5-methylphenyl)heptane, 1,1-bis(2-tert-butyl-4-hydroxy-5-methylphenyl)-1-phenylmethane, 1,1-bis(2-tert-amyl-4-hydroxy-5-methylphenyl)butane, bis(3-chloro-4-hydroxyphenyl)methane, bis(3,5-dibromo-4-hydroxyphenyl)methane, 2,2-bis(3-chloro-4-hydroxyphenyl)propane, 2,2-bis(3-fluoro-4-hydroxyphenyl)propane, 2,2-bis(3-bromo-4-hydroxyphenyl)propane, 2,2-bis(3,5-difluoro-4-hydroxyphenyl)propane, 2,2-bis(3,5-dichloro-4-hydroxyphenyl)propane, 2,2-bis(3,5-dibromo-4-hydroxyphenyl)propane, 2,2-bis(3-bromo-4-hydroxy-5-chlorophenyl)propane, 2,2-bis(3,5-dichloro-4-hydroxyphenyl)butane, 2,2-bis(3,5-dibromo-4-hydroxyphenyl)butane, 1-phenyl-1,1-bis(3-fluoro-4-hydroxyphenyl)ethane, bis(3-fluoro-4-hydroxyphenyl) ether, 1,1-bis(3-cyclohexyl-4-hydroxyphenyl)cyclohexane, and the like.

One alone or two or more of those bisphenol compounds may be used here either singly or as combined.

Of those, the BP polycarbonate resin is preferably a polycarbonate resin having a structural unit represented by the following general formula (PCA) and a structural unit represented by the following general formula (PCB), from the viewpoint of the abrasion resistance of the photosensitive layer (charge transport layer).

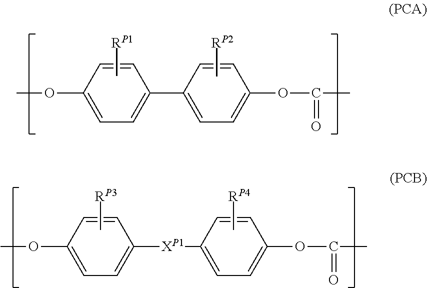

In the general formulae (PCA) and (PCB), R^{P1}, R^{P2}, R^{P3} and R^{P4} each independently represent a hydrogen atom, a halogen atom, an alkyl group having from 1 to 6 carbon atoms, a cycloalkyl group having from 5 to 7 carbon atoms, or an aryl group having from 6 to 12 carbon atoms. X^{P1} represents a phenylene group, a biphenylene group, a naphthylene group, an alkylene group or a cycloalkylene group.

In the general formulae (PCA) and (PCB), the alkyl group represented by R^{P1}, R^{P2}, R^{P3} and R^{P4} includes a linear or branched alkyl group having from 1 to 6 carbon atoms (preferably from 1 to 3 carbon atoms).

The linear alkyl group includes concretely a methyl group, an ethyl group, an n-propyl group, an n-butyl group, an n-pentyl group, an n-hexyl group, and the like.

The branched alkyl group includes concretely an isopropyl group, an isobutyl group, a sec-butyl group, a tert-butyl group, an isopentyl group, a neopentyl group, a tert-pentyl group, an isohexyl group, a sec-hexyl group, a tert-hexyl group, and the like.

Of those, as the alkyl group, preferred is a lower alkyl group such as a methyl group, an ethyl group, and the like.

In the general formulae (PCA) and (PCB), the cycloalkyl group represented by R^{P1}, R^{P2}, R^{P3} and R^{P4} includes, for example, a cyclopentyl, cyclohexyl, cycloheptyl, and the like.

In the general formulae (PCA) and (PCB), the aryl group represented by R^{P1}, R^{P2}, R^{P3} and R^{P4} includes, for example, a phenyl group, a naphthyl group, a biphenylyl group, and the like.

In the general formulae (PCA) and (PCB), the alkylene group represented by X^{P1} includes a linear or branched alkylene group having from 1 to 12 carbon atoms (preferably from 1 to 6 carbon atoms, more preferably from 1 to 3 carbon atoms).

The linear alkylene group concretely includes a methylene group, an ethylene group, an n-propylene group, an n-butylene group, an n-pentylene group, an n-hexylene group, a n-heptylene group, an n-octylene group, an n-nonylene group, an n-decylene group, an n-undecylene group, an n-dodecylene group, and the like.

The branched alkylene group includes concretely an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isobutylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, a ten-decylene group, an isoundecylene group, a sec-undecylene group, a tert-undecylene group, a neoundecylene group, an isododecylene group, a sec-dodecylene group, a tert-dodecylene group, a neododecylene group, and the like.

Of those, as the alkylene group, preferred is a lower alkylene group such as a methylene group, an ethylene group, a butylene group, and the like.

In the general formulae (PCA) and (PCB), the cycloalkylene group represented by X^{P1} includes a cycloalkylene group having from 3 to 12 carbon atoms (preferably from 3 to 10 carbon atoms, more preferably from 5 to 8 carbon atoms).

The cycloalkylene group concretely includes a cyclopropylene group, a cyclopentylene group, a cyclohexylene group, a cyclooctylene group, a cyclododecanylene group, and the like.

Of those, as the cycloalkylene group, preferred is a cyclohexylene group.

In the general formulae (PCA) and (PCB), the above-mentioned substituents represented by R^{P1}, R^{P2}, R^{P3}, R^{P4} and X^{P1} include those further having a substituent. The additional substituent for those substituents includes, for example, a halogen atom (for example, a fluorine atom, a chlorine atom), an alkyl group (for example, an alkyl group having from 1 to 6 carbon atoms), a cycloalkyl group (for example, a cycloalkyl group having from 5 to 7 carbon atoms), an alkoxy group (for example, an alkoxy group having from 1 to 4 carbon atoms), an aryl group (for example, a phenyl group, a naphthyl group, a biphenylyl group) such as those mentioned hereinabove.

In the general formula (PCA), preferably, R^{P1} and R^{P2} each are independently a hydrogen atom or an alky group having from 1 to 6 carbon atoms, and more preferably R^{P1} and R^{P2} are hydrogen atoms.

In the general formula (PCB), preferably, R^{P3} and R^{P4} each are independently a hydrogen atom or an alkyl group having from 1 to 6 carbon atoms, and X^{P1} is an alkylene group or a cycloalkylene group.

Specific examples of the BP polycarbonate resin are, for example, those mentioned below, to which, however, the present invention is not limited. In the exemplified compounds, pm and pn each indicates a copolymerization ratio.

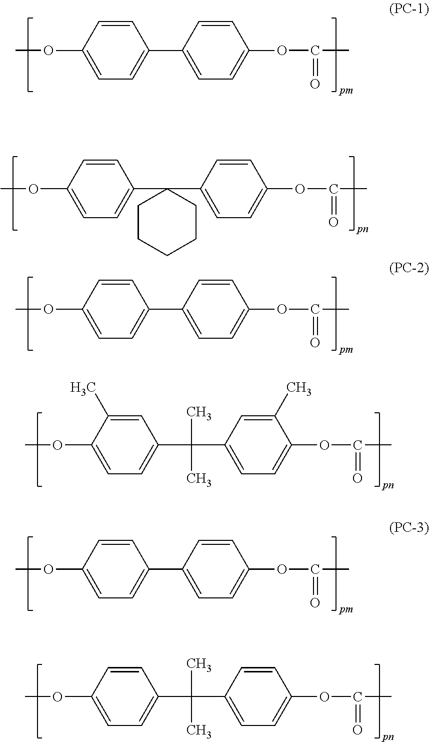

Here, in the BP polycarbonate resin, the content (copolymerization ratio) of the structural unit represented by the general formula (PCA) preferably falls within a range of from 5 mol % to 95 mol % relative to all the structural units constituting the BP polycarbonate resin, and from the viewpoint of increasing the abrasion resistance of the photosensitive layer (charge transport layer), the content is preferably within a range of from 5 mol % to 50 mol %, more preferably from 15 mol % to 30 mol %.

Concretely, in the exemplified compounds of the BP polycarbonate resin shown above, pm and pn each indicates the copolymerization of each compound, falling within a range of from 95/5 to 5/95 as pm/pn, preferably from 50/50 to 5/95, and more preferably from 15/85 to 30/70.

The viscosity-average molecular weight of the BP polycarbonate resin is, for example, preferably from 20,000 to 80,000.

The viscosity-average molecular weight of the BP polycarbonate resin is a value to be measured according to the following method. One g of the resin is uniformly dissolved in 100 cm³ of methylene chloride, and using an Ubbelohde viscometer in a measurement environment at 25° C., the specific viscosity ηsp thereof is measured. With that, according to a relational expression of ηsp/c=[η]+0.45[η]2c (where c means the concentration (g/cm³) of the solution), the limiting viscosity [η](cm³/g) is calculated, and according to a relational expression given by H. Schnell, [η]=1.23×10⁻⁴ Mv^{0.83}, the viscosity-average molecular weight Mv of the resin is thus determined.

The BP polycarbonate resin may be combined with any other binder resin for use herein. However, it is desirable that the content of the other binder resin to be used in combination is 10% by weight or less (more preferably 5% by weight or less) relative to the amount of all the binder resins.

Here, the content of the BP polycarbonate resin is, for example, preferably from 10% by weight to 90% by weight relative to the entire solid content in the photosensitive layer (charge transport layer), more preferably from 30% by weight to 90% by weight, even more preferably from 50% by weight to 90%/o by weight.

The blend ratio of all binder resins and the charge-transporting material (ratio by weight of binder resins/charge-transporting material) is preferably from 10/1 to 1/5.

Next described are fluorine-containing resin particles.

The fluorine-containing resin particles for use herein are, for example, preferably selected from one or more types of particles of tetrafluoroethylene resin, trifluorochloroethylene resin, hexafluoropropylene resin, vinyl fluoride resin, vinylidene fluoride resin, difluorodichloroethylene resin and copolymers thereof. Of those, as the fluorine-containing resin particles, especially preferred are tetrafluoroethylene resin particles and vinylidene fluoride resin particles.

The primary particle size of the fluorine-containing resin particles is preferably from 0.05 μm to 1 μm, more preferably from 0.1 μm to 0.5 μm.

The primary particle size is determined as follows. A sample piece is cut out of the photosensitive layer (charge transport layer) to be analyzed, this is observed with SEM (scanning electronic microscope) at, for example, a 5000-power magnification or more to measure the maximum diameter of the fluororesin particles in the form of primary particles. 50 particles are thus measured, and the data thereof are averaged. As SEM, used is JEOL's JSM-6700F, and the secondary electron image under an acceleration voltage of 5 kV is analyzed.

As commercial products of fluororesin particles, for example, there are mentioned Rublon (registered TM) series (by Daikin Industries), Teflon (registered TM) series (by DuPont), Dyneon (registered TM) series (by Sumitomo 3M), or the like.

The content of the fluorine-containing resin particles is preferably from 1% by weight to 30% by weight, more preferably from 3% by weight to 20% by weight, even more preferably from 5% by weight to 15% by weight relative to the total solid content of the photosensitive layer (charge transport layer), from the viewpoint of improving the abrasion resistance of the photosensitive layer and of prolonging the life of the photoreceptor.

Next described is the fluorine-containing dispersant.

The fluorine-containing dispersant includes a homopolymer or a copolymer of a polymerizable compound having a fluoroalkyl group (hereinafter this may be referred to as “fluoroalkyl group-containing polymer”).

Concretely, the fluorine-containing dispersant includes a homopolymer of a (meth)acrylate having a fluoroalkyl group, a random or block copolymer of a (meth)acrylate having a fluoroalkyl group and a monomer not having a fluorine atom, and the like. (Meth)acrylate means both an acrylate and a methacrylate.

The (meth)acrylate having a fluoroalkyl group includes, for example, 2,2,2-trifluoroethyl (meth)acrylate, 2,2,3,3,3-pentafluoropropyl (meth)acrylate, and the like.

The monomer not having a fluorine atom includes, for example, (meth)acrylate, isobutylene (meth)acrylate, t-butyl (meth)acrylate, isooctyl (meth)acrylate, lauryl (meth)acrylate, stearyl (meth)acrylate, isobornyl (meth)acrylate, cyclohexyl (meth)acrylate, 2-methoxyethyl (meth)acrylate, methoxytriethylene glycol (meth)acrylate, 2-ethoxyethyl (meth)acrylate, tetrahydrofurfuryl (meth)acrylate, benzyl (meth)acrylate, ethylcarbitol (meth)acrylate, phenoxyethyl (meth)acrylate, 2-hydroxyethyl (meth)acrylate, 2-hydroxypropyl (meth)acrylate, 4-hydroxybutyl (meth)acrylate, methoxypolyethylene glycol (meth)acrylate, phenoxypolyethylene glycol (meth)acrylate, o-phenylphenol (meth)acrylate, o-phenylphenol glycidyl ether (meth)acrylate, and the like.

In addition, concretely as the fluorine-containing dispersant, further mentioned are block or branch polymers. Moreover, also concretely as the fluorine-containing dispersant, additionally mentioned are fluorine-containing surfactants.

Of those, as the fluorine-containing dispersant, preferred are fluoroalkyl group-containing polymers having a structural unit represented by the following general formula (FA), and more preferred are fluoroalkyl group-containing polymers having a structural unit represented by the following general formula (FA) and having a structural unit represented by the following general formula (FB).

The fluoroalkyl group-containing polymers having a structural unit represented by the following general formula (FA) and having a structural unit represented by the following general formula (FB) are described hereinunder.

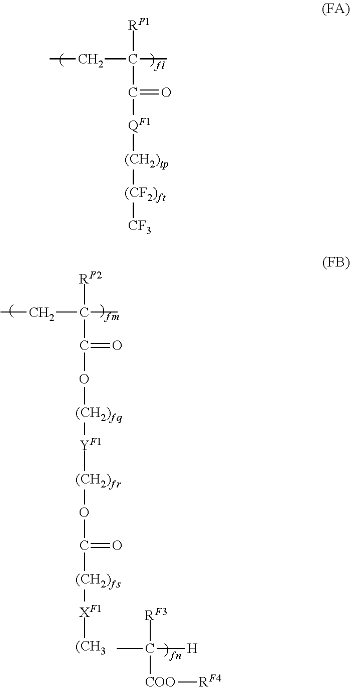

In the general formulae (FA) and (FB), R^{F1}, R^{F2}, R^{F3} and R^{F4} each independently represent a hydrogen atom or an alkyl group.

X^{F1} represents an alkylene chain, a halogen-substituted alkylene chain, —S—, —O—, —NH— or a single bond.

Y^{F1} represents an alkylene chain a halogen-substituted alkylene chain, —(C_{fx}H_{2fx-J}(OH))— or a single bond.

Q^{F1} represents —O— or —NH—.

fl, fm and fn each independently indicate an integer of 1 or more.

fp, fg, fr and fs each independently indicate 0 or an integer of 1 or more.

ft indicates an integer of from 1 to 7.

fx indicates an integer of 1 or more.

In the general formulae (FA) and (FB), the group represented by R^{F1}, R^{F2}, R^{F3} and R^{F4} is preferably a hydrogen atom, a methyl group, an ethyl group, a propyl group, or the like, more preferably a hydrogen atm or a methyl group, and even more preferably a methyl group.

In the general formulae (FA) and (FB), the alkylene chain (unsubstituted alkylene chain, halogen-substituted alkylene chain) represented by X^{F1} and Y^{F1} is preferably a linear or branched alkylene chain having from 1 to 10 carbon atoms.

fx in —(C_{fx}H_{2fx-1}(OH))— represented by Y^{F1} is preferably an integer of from 1 to 10.

fp, fg, fr and fs each are independently preferably an integer of from 1 to 10.

fn is, for example, preferably from 1 to 60.

Here, in the fluorine-containing dispersant, the ratio of the structural unit represented by the general formula (FA) and the structural unit represented by the general formula (FR), or that is fl/fm is preferably within a range of from 1/9 to 9/1, more preferably within a range of from 3/7 to 7/3.

The fluorine-containing dispersant may further contain a structural unit represented by the following general formula (FC), in addition to the structural unit represented by the general formula (FA) and the structural unit represented by the general formula (FB). The content ratio of the structural unit represented by the general formula (FC) relative to the total of the structural units represented by the general formulae (FA) and (FB), or that is, the ratio of (fl+fm) to fz, (fl+fm)/fz, is preferably within a range of from 10/0 to 7/3, more preferably within a range of from 9/1 to 7/3.

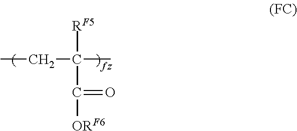

In the general formula (FC). R^{F5} and R^{F6} each independently represent a hydrogen atom or an alkyl group. fz indicates an integer of 1 or more.

In the general formula (FC), the group represented by R^{F5} and R^{F6} is preferably a hydrogen atom, a methyl group, an ethyl group, a propyl group, or the like, more preferably a hydrogen atom or a methyl group, even more preferably a methyl group.

Commercial products of the fluorine-containing dispersant include, for example, GF300 and GF400 (by Toagosei) Surflon series (by AGC Seimi Chemical), Phthagent series (by Neos), PF series (by Kitamura Chemical), Megafac series (by DIC), FC series (by 3M), and the like.

The weight-average molecular weight of the fluorine-containing dispersant is, for example, preferably from 2000 to 250000, more preferably from 3000 to 150000, even more preferably from 50000 to 100000.

The weight-average molecular weight of the fluorine-containing dispersant is measured through gel permeation chromatography (GPC). For molecular weight measurement through GPC, for example, Tosoh's GPC HLC-8120 is used as the measurement apparatus with Tosoh's columns TSKgel GMHHR-M+TSKgel GMHHR-M (7.8 mm i.d., 30 cm), using a chloroform solvent. From the found data, the intended molecular weight is calculated using the molecular weight calibration curve of a monodispersed polystyrene standard sample.

The content of the fluorine-containing dispersant is, for example, preferably from 0.50% by weight to 10% by weight relative to the weight of the fluorine-containing resin particles, more preferably from 1% by weight to 7% by weight, from the viewpoint of the dispersibility of the fluorine-containing dispersant and from the viewpoint of preventing burn-in ghosting and optical fatigue in the photoreceptor.

One alone or two or more types of fluorine-containing dispersants may be used here either singly or as combined.

Not specifically defined, any known formation method is employable in forming the charge transport layer. For example, a coating film of a charge transport layer-forming coating liquid prepared by adding the above-mentioned components in a solvent is formed, and the coating film is dried and optionally heated to form the layer.

As the solvent for use in preparing the charge transport layer-forming coating liquid, usable here is any ordinary organic solvent that includes aromatic hydrocarbons such as benzene, toluene, xylene, chlorobenzene; ketones such as acetone, 2-butanone; halogenated aliphatic hydrocarbons such as methylene chloride, chloroform, ethylene chloride; cyclic or linear ethers such as tetrahydrofuran, ethyl ether. One alone or two or more of those solvents may be used either singly or as combined.

As the method of applying the charge transport layer-forming coating liquid onto the charge generation layer, there are mentioned ordinary methods such as a blade coating method, a wire bar coating method, a spray coating method, a dip coating method, a bead coating method, an air knife coating method, a curtain coating method.

The thickness of the charge transport layer is defined, for example, to fall preferably within a range of from 5 μm to 50 μm, more preferably from 10 μm to 30 μm.

### (Protective Layer)

If desired, a protective layer is provided on the photosensitive layer. The protective layer is provided, for example, for protecting the photosensitive layer in charging from chemical change and for further improving the mechanical strength of the photosensitive layer.

For that purpose, it is desirable that a layer formed of a cured film (crosslinked film) is applied to the protective film. As the layer, for example, the following 1) or 2) is mentioned.

1) A layer formed of a cured film of a composition that contains a reactive group-containing charge-transporting material having both a reactive group and a charge-transporting skeleton in one and the same molecule (in other words, a layer that contains a polymer or a crosslinked product of the reactive group-containing charge-transporting material).

2) A layer formed of a cured film of a composition that contains a nonreactive charge-transporting material and a reactive group-containing non-charge-transporting material having a reactive group but not having a charge-transporting skeleton (in other words, a layer that contains a non-reactive charge-transporting material and a polymer or a crosslinked product of the reactive group-containing non-charge-transporting material).

As the reactive group in the reactive group-containing charge-transporting material, there are mentioned known reactive groups such as a chain-polymerizing group, an epoxy group, —OH, —OR (where R represents an alkyl group), —NH₂, —SH—, —COOH, —SiR^{Q1}_{3-Qn}(OR^{Q2})_{Qn} (wherein R^{Q1} represents a hydrogen atom, an alkyl group, or a substituted or unsubstituted aryl group, R^{Q2} represents a hydrogen atom, an alkyl group or a trialkylsilyl group, Qn indicates an integer of from 1 to 3), or the like.

Not specifically defined, the chain-polymerizing group may be any radical-polymerizable functional group, and is, for example, a functional group at least having a carbon double bond-containing group. Concretely, there are mentioned groups containing at least one selected from a vinyl group, a vinyl ether group, a vinyl thioether group, a styryl group, a vinylphenyl group, an acryloyl group, a methacryloyl group, and their derivatives. Above all, as excellent in reactivity, the chain-polymerizing group is preferably a group containing at least one selected from a vinyl group, a vinylphenyl group, an acryloyl group, a methacryloyl group and their derivatives.

The charge-transporting skeleton in the reactive group-containing charge-transporting material may be, not specifically defined, any known structure in electrophotographic photoreceptors. For example, as the skeleton, there is mentioned a skeleton structure derived from a nitrogen-containing hole-transporting compound such as a triarylamine compound, a benzidine compound, a hydrazone compound or the like and conjugate with the nitrogen atom therein. Of those, preferred is a triarylamine skeleton.

The reactive group-containing charge-transporting material having a reactive group and a charge-transporting skeleton, the non-reactive charge-transporting material and the reactive group-containing non-charge-transporting material may be selected from known materials.

The protective layer may contain any other known additive.

Not specifically defined, any known formation method is applicable to the formation of the protective group. For example, a coating film of a protective layer-forming coating liquid prepared by adding the above-mentioned components to a solvent is formed, and the coating film is dried and optionally cured through heating or the like to form the layer.

As the solvent for use in preparing the protective layer-forming coating liquid, usable here is any ordinary organic solvent that includes aromatic hydrocarbons such as toluene, xylene; ketones such as methyl ethyl ketone, methyl isobutyl ketone, cyclohexanone; ester solvents such as ethyl acetate, butyl acetate; ether solvents such as tetrahydrofuran, dioxane; cellosolve solvents such as ethylene glycol monomethyl ether; alcohol solvents such as isopropyl alcohol, butanol. One alone or two or more of those solvents may be used either singly or as combined.

The protective layer-forming coating liquid may be a solvent-free coating liquid.

As the method of applying the protective layer-forming coating liquid onto the photosensitive layer (for example, charge transport layer), there are mentioned ordinary methods such as a dip coating method, a toss coating method, a wire bar coating method, a spray coating method, a blade coating method, a knife coating method, a curtain coating method, and the like.

The thickness of the protective layer is, for example, preferably defined within a range from 1 μm to 20 μm, more preferably from 2 μm to 10 μm.

### (Single-Layer Photosensitive Layer)

The single-layer photosensitive layer (charge generation/charge transport layer) is, for example, a layer containing a charge-generating material, a charge-transporting material, and optionally a binder resin and any other known additive. These materials are the same materials as those described hereinabove for the charge generation layer and the charge transport layer.

In the single-layer photosensitive layer, the content of the charge-generating material is preferably from 10% by weight to 85% by weight relative to the total solid content in the layer, more preferably from 20% by weight to 50% by weight.

On the other hand, in the single-layer photosensitive layer, the content of the charge-transporting material, the binder resin (BP polycarbonate), the fluorine-containing resin particles, the fluorine-containing dispersant, the antioxidant and the UV absorbent is the same as that of those components in the charge transport layer described hereinabove.

The formation method for the single-layer photosensitive layer is the same as the formation method for the charge generation layer and the charge transport layer.

The thickness of the single-layer photosensitive layer is, for example, preferably from 5 μm to 50 μm, more preferably from 10 μm to 40 μm.

### [Image Forming Apparatus (and Process Cartridge)]

The image forming apparatus of this embodiment includes an electrophotographic photoreceptor, a charging unit of charging the surface of the electrophotographic photoreceptor, an electrostatic latent image formation unit of forming an electrostatic latent image on the charged surface of the electrophotographic photoreceptor, a development unit of developing the electrostatic latent image formed on the surface of the electrophotographic photoreceptor, using a developer containing a toner to form a toner image, and a transfer unit of transferring the toner image to the surface of a recording medium. The electrophotographic photoreceptor of the above-mentioned embodiment of the present invention is applied to the electrophotographic photoreceptor in the device of this embodiment.

Any known image forming apparatus is applicable to the image forming apparatus of this embodiment, for example, a device including a fixation unit of fixing the toner image transferred to the surface of a recording medium; a direct transfer system device of transferring the toner image formed on the surface of an electrophotographic photoreceptor directly to a recording medium; an intermediate transfer system device where the toner image formed on the surface of an electrophotographic photoreceptor is primarily transferred to the surface of an intermediate transfer medium, and the toner image thus transferred to the surface of the intermediate transfer medium is secondarily transferred to the surface of a recording medium; a device equipped with a cleaning unit of cleaning the surface of the electrophotographic photoreceptor prior to being charged after toner image transfer; a device equipped with a neutralization unit of neutralizing the surface of the image holder through irradiation thereof with neutralization light prior to being charged and after toner image formation; a device equipped with an electrophotographic photoreceptor heating member of heating the electrophotographic photoreceptor to lower the relative humidity therein or the like is applicable thereto.

In the intermediate transfer system device, for example, a construction including an intermediate transfer medium on the surface of which a toner image is to be transferred, a primary transfer unit of primarily transferring the toner image formed on the surface of the image holder to the surface of the intermediate transfer medium, and a secondary transfer unit of secondarily transferring the toner image transferred on the surface of the intermediate transfer medium, to the surface of a recording medium, is applicable to the transfer unit.

The image forming apparatus of this embodiment may be any of a dry development system image forming apparatus, or a wet development system (development system using a liquid developer) image forming apparatus.

In the image forming apparatus of this embodiment, for example, the part having the electrophotographic photoreceptor may have a cartridge structure (process cartridge) attachable to or detachable from the image forming apparatus. As the process cartridge, for example, preferred is a process cartridge that includes the electrophotographic photoreceptor of the above-mentioned embodiment of the present invention. The process cartridge may be provided with, for example, at least one selected from a group consisting of a charging unit, an electrostatic latent image formation unit, a development unit and a transfer unit, in addition to the electrophotographic photoreceptor therein.

Examples of the image forming apparatus of this embodiment are described below, to which, however, the present invention is not limited. Main parts in the drawings are described below, and description of the others is omitted here.

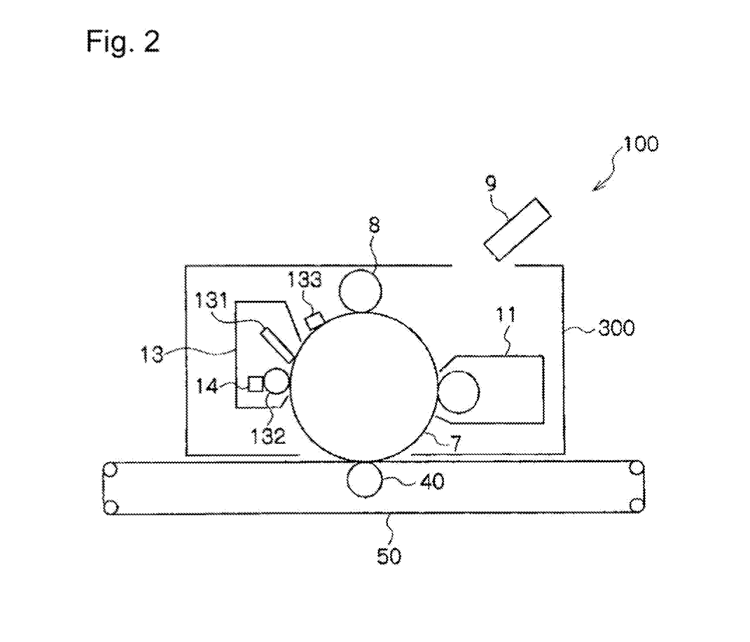

FIG. 2 is a skeleton framework view showing one example of the image forming apparatus of this embodiment of the present invention.

The image forming apparatus 100 in this embodiment includes, as shown in FIG. 2, the process cartridge 300 equipped with the electrophotographic photoreceptor 7, the exposure unit 9 (one example of the electrostatic latent image formation unit), the transfer unit 40 (primary transfer unit), and the intermediate transfer medium 50. In the image forming apparatus 100, the exposure unit 9 is arranged at the position from which the electrophotographic photoreceptor 7 may be exposed thereto via the opening of the process cartridge 300, the transfer unit 40 is arranged at the position opposite to the electrophotographic photoreceptor 7 via the intermediate transfer medium 50, and the intermediate transfer medium 50 is so arranged that a part thereof is kept in contact with the electrophotographic photoreceptor 7. Though not shown, the device further includes a secondary transfer unit of transferring the toner image transferred on the intermediate transfer medium 50, to a recording medium (for example, copy paper). The intermediate transfer medium 50, the transfer unit 40 (primary transfer unit), and the secondary transfer unit (not shown) correspond to examples of the transfer unit.

The process cartridge 300 in FIG. 2 includes, as integrally supported in the housing, the electrophotographic photoreceptor 7, the charging unit 8 (one example of the charging unit), the development unit 11 (one example of the development unit), and the cleaning unit 13 (one example of the cleaning unit). The cleaning unit 13 has the cleaning blade 131 (one example of a cleaning member), and the cleaning blade 131 is so arranged as to be in contact with the surface of the electrophotographic photoreceptor 7. Not limited to the embodiment of the cleaning blade 131, the cleaning member may also be a conductive or insulating fibrous member, and this may be used here either alone or as combined with the cleaning blade 131.

The image forming apparatus of the embodiment shown in FIG. 2 includes a fibrous member 132 (as a roll) for supplying a lubricant 14 to the surface of the electrophotographic photoreceptor 7, and a fibrous member 133 (as a flat brush) for assisting the cleaning, in which, however, these members are optional ones.

Next described hereinunder are the constitutive components of the image forming apparatus of this embodiment of the present invention.

### —Charging Unit—

As the charging unit 8, for example, employable here is a contact charger using a conductive or semiconductive charging roller, a charging brush, a charging film, a charging rubber blade, a charging tube or the like. Also employable is any per-se known charger such as a noncontact roller charger, a scorotron charger or a corotron charger using corona discharging.

### —Exposure Unit—

As the exposure unit 9, for example, there may be mentioned an optical apparatus or the like capable of predeterminedly imagewise exposing the surface of the electrophotographic photoreceptor 7 to light such as semiconductor laser light, LED light, liquid-crystal shutter light or the like. The wavelength of the light source is to fall within the spectral sensitivity range of the electrophotographic photoreceptor. The wavelength of semiconductor laser is mainly in near IR range having an oscillation wavelength at around 700 nm. However, the present invention is not limited to this wavelength, and any other laser such as a laser having an oscillation wavelength of 600 nm or so or a blue laser having an oscillation wavelength of from 400 nm to 450 nm may also be used here. In addition, for color image formation, a surface-emitting laser source of a type capable of outputting a multibeam light is also effective.

### —Development Unit—

As the development unit 11, for example, there is mentioned an ordinary development device for contact or noncontact development with a developer. Not specifically defined, the development unit 11 may be any one having the above-mentioned function, and may be selected for use herein depending on the purpose thereof. For example, there is mentioned a known developing machine having a function of adhering a one-pack developer or a two-pack developer to the electrophotographic photoreceptor 7 using a brush, a roller or the like. Especially preferred is use of a developing roller capable of holing a developer on the surface thereof.

The developer for use in the development unit 11 may be either a one-pack developer of a toner alone, or a two-pack developer containing a toner and a carrier. The developer may be magnetic or nonmagnetic. Any known developer is employable here.

### —Cleaning Unit—

As the cleaning unit 13, employable here is a cleaning blade-type unit equipped with the cleaning blade 131.

Except the cleaning blade-type unit, any others are also usable here, including a fur brush cleaning system and a simultaneous development-cleaning system.

### —Transfer Unit—

As the transfer unit 40, for example, there are mentioned per-se known transfer chargers such as a contact transfer charger using a belt, a roller, a film, a rubber blade or the like, as well as a scorotron transfer charger, a corotron transfer charger and the like using corona discharging.

### —Intermediate Transfer Medium—

As the intermediate transfer medium 50, usable here is a belt-like medium containing a semiconductive polyimide, polyamideimide, polycarbonate, polyarylate, polyester, rubber or the like (intermediate transfer belt). Regarding the form of the intermediate transfer medium, also usable is a drum-like one in addition to the belt-like one.

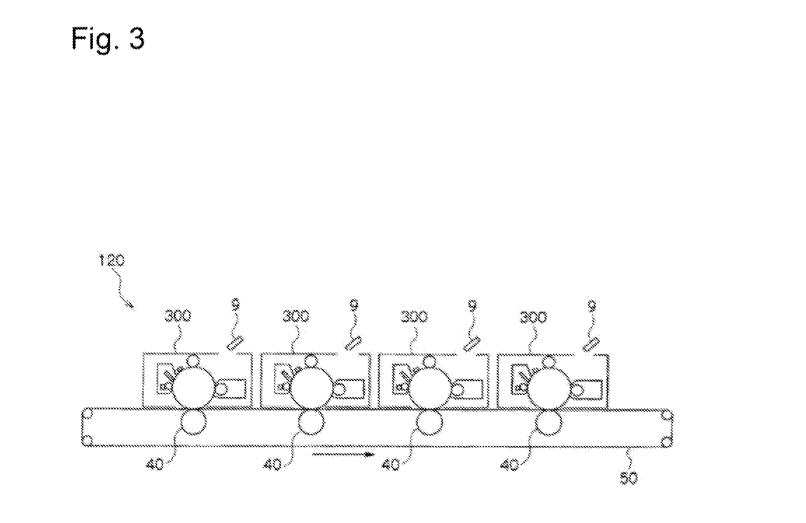

FIG. 3 is a skeleton framework view showing another example of the image forming apparatus of this embodiment of the present invention.

The image forming apparatus 120 shown in FIG. 3 is a tandem-type multicolor image forming apparatus having four process cartridges 300 mounted thereon. The image forming apparatus 120 includes those four process cartridges 300 arranged in parallel to each other on the intermediate transfer medium 50 therein, and is so designed that one electrophotographic photoreceptor is used for each one color. The configuration of the image forming apparatus 120 is the same as that of the image forming apparatus 100 except that the former is a tandem-system one.

### EXAMPLES

Examples of the present invention are described hereinafter, however, the present invention is not limited to the following Examples.

### Example 1-1

100 parts by weight of zinc oxide (trade name: MZ 300, by TAYCA CORPORATION), 10 parts by weight of a toluene solution of 10% by weight of a silane coupling agent, N-2-(aminoethyl)-3-aminopropyltriethoxysilane, and 200 parts by weight of toluene are mixed, stirred and refluxed for 2 hours. Subsequently, toluene is evaporated away under a reduced pressure of 10 mmHg, and the residue is baked at 135° C. for 2 hours for surface treatment of zinc oxide with the silane coupling agent.

33 parts by weight of the surface-treated zinc oxide, 6 parts by weight of a blocked isocyanate (trade name: Sumidur 3175, by Sumitomo Bayer Urethane Corporation), 1 part by weight of a compound represented by the following structural formula (AK-1), and 25 parts by weight of methyl ethyl ketone are mixed for 30 minutes, and then 5 parts by weight of a butyral resin (trade name: S-LEC BM-1, by SEKISUI CHEMICAL CO., LTD.), 3 parts by weight of silicon balls (trade name: Tospearl 120, by Momentive Performance Materials Inc.), and 0.01 parts by weight of a leveling agent of silicone oil (trade name: SH29PA, by Toray Dow Corning Corporation) are added thereto, and dispersed with a sand mill for 3 hours to prepare an undercoat layer-forming coating liquid.

According to a dip coating method, the underlayer-forming coating liquid is applied onto an aluminum substrate having a diameter of 47 mm, a length of 357 mm and a thickness of 1 mm, and dried and cured at 180° C. for 30 minutes to form thereon an undercoat layer having a thickness of 25 μm.

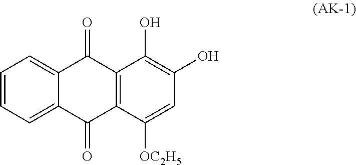 [SMILES: CCOc1cc(O)c(O)c2c1C(=O)c1ccccc1C2=O]

Next, a mixture containing a charge-generating material of hydroxygallium phthalocyanine pigment “V-type hydroxygallium phthalocyanine pigment having, in the X-ray diffraction spectrum thereof using a CuKα characteristic X ray, diffraction peaks at the Bragg angle (2θ±0.2*) of at least 7.3°, 16.0°, 24.9° and 28.0° (maximum peak wavelength in the spectral absorption spectrum in a wavelength of from 600 nm to 900 nm=820 nm, mean particle size=0.12 μm, maximum particle size=0.2 μm, specific surface area value=60 m²/g)”, a binder resin of vinyl chloride-vinyl acetate copolymer resin (trade name: VMCH, by NUC Corporation), and n-butyl acetate was put into a 100-mL glass bottle along with 1.0 mmφ glass beads at a filling rate of 50%, and dispersed for 2.5 hours using a paint shaker to prepare a charge generation layer-forming coating liquid. The content of hydroxygallium phthalocyanine pigment relative to the mixture of hydroxygallium phthalocyanine pigment and vinyl chloride-vinyl acetate copolymer resin was 55.0% by volume, and the solid content of the dispersion was 6.0% by weight. In calculating the content, the specific gravity of hydroxygallium phthalocyanine pigment is 1.606 g/cm³, and the specific gravity of vinyl chloride-vinyl acetate copolymer resin is 1.35 g/cm³.

Thus prepared, the charge generation layer-forming coating liquid was applied onto the undercoat layer in a mode of dip coating, and dried at 100° C. for 5 minutes to form a charge generation layer having a thickness of 0.20 μm.

Next, as charge-transporting materials, 8.0 parts by weight of a butadiene charge-transporting material (CT1) “exemplified compound (CT1-1) and 32.0 parts by weight of a benzidine charge-transporting material (CT2) “exemplified compound (CT2-1); as a binder resin, 60.0 parts by weight of a bisphenol Z-type polycarbonate resin (bisphenol Z homopolymer-type polycarbonate resin, having a viscosity-average molecular weight of 40,000); and as an antioxidant, 3.2 parts by weight of a hindered phenol antioxidant “exemplified compound (HP-1), having a molecular weight of 775” (8.0% by weight relative to 100% by weight of the total amount of all the charge-transporting materials) are added and dissolved in 340.0 parts by weight of tetrahydrofuran to prepare a charge transport layer-forming coating liquid.

The resultant, charge transport layer-forming coating liquid is applied onto the charge generation layer in a mode of dip coating, and dried at 150° C. for 40 minutes to form a charge transport layer having a thickness of 34 μm.

According to the above-mentioned process, an electrophotographic photoreceptor is produced.

### Examples 1-2 to 1-4

Electrophotographic photoreceptors are produced in the same manner as in Example 1-1 except that the type of the charge-transporting materials and the type of the hindered phenol antioxidant are changed as in Table 1.

### Example 1-5

An electrophotographic photoreceptor is produced in the same manner as in Example 1-1 except that, in place of the hindered phenol antioxidant which is an antioxidant, 3.2 parts by weight of a benzophenone UV absorbent “exemplified compound (BP-1)” (8.0% by weight relative to 100% by weight of the total amount of all the charge-transporting materials) is used.

### Examples 1-6 to 1-8

Electrophotographic photoreceptors are produced in the same manner as in Example 1-5 except that the type of the charge-transporting materials and the type of the benzophenone UV absorbent are changed as in Table 1.

### Example 1-9

An electrophotographic photoreceptor is produced in the same manner as in Example 1-1 except that 3.2 parts by weight of a hindered phenol antioxidant as an antioxidant “exemplified compound (HP-1), having a molecular weight of 775” (8.0% by weight relative to 100% by weight of the total amount of all the charge-transporting materials) and 3.2 parts by weight of a benzophenone UV absorbent as a UV absorbent “exemplified compound (BP-1)” (8.0% by weight relative to 100% by weight of the total amount of all the charge-transporting materials) are used.

### Example 1-10

An electrophotographic photoreceptor is produced in the same manner as in Example 1-9 except that the type of the hindered phenol antioxidant and the type of the benzophenone UV absorbent are changed as in Table 1.

### Examples 1-11 to 1-20

Electrophotographic photoreceptors are produced in the same manner as in Example 1-9 except that the type of the charge-transporting materials, the type of the hindered phenol antioxidant and the type of the benzophenone UV absorbent are changed as in Table 1.

### Examples 1-21 to 1-25

Electrophotographic photoreceptors are produced in the same manner as in Example 1-20 except that the amount of the hindered phenol antioxidant which is an antioxidant and the amount of the benzophenone UV absorbent which is a UV absorbent are changed as in Table 1.

### Examples 1-26 to 1-31

Electrophotographic photoreceptors are produced in the same manner as in Example 1-20 except that the amount of the charge-transporting materials is changed as in Table 1.

### Comparative Examples 1-1 to 1-6

Electrophotographic photoreceptors are produced in the same manner as in Example 1-9 except that the type of the charge-transporting materials, the type of the antioxidant and the type of the UV absorbent are changed as in Table 2.

### [Evaluation]

The electrophotographic photoreceptors produced in Examples are evaluated in point of “burn-in ghosting”, “optical fatigue” and “halftone image density” therein, according to the manner described below.

### (Evaluation of Burn-in Ghosting)

The electrophotographic photoreceptor produced in each Example is mounted on an electrophotographic image forming apparatus (Versant 2100 Press manufactured by Fuji Xerox Co., Ltd.), a lattice pattern chart is continuously outputted on 3000 sheets of A3-size paper to give 3000 copies of the pattern chart, and thereafter a full-page halftone image (a full-page halftone image of cyan color) having an image density of 20% is outputted on one sheet of A3-size paper to give one copy of the image.

Thus outputted, the full-page halftone image is observed, and the density difference between the continuous image-outputted part and the discontinuous image-outputted part of the lattice pattern is visually determined for organoleptic evaluation (grade judgment). The grade judgment covers from 0G to 5G at intervals of 0.5G. In the test, the samples having a smaller numerical value G are to have a smaller density difference and therefore suffer from little burn-in ghosting. The acceptable grade of burn-in ghosting is 3.50 or less. In every case, image outputting is in an environment at 28° C. and 85% RH. The results are shown in Table 1 and Table 2.

### (Evaluation of Optical Fatigue)

First, the electrophotographic photoreceptor produced in each Example is wound around a black paper having a 2-cm square window formed therein, and left under a white fluorescent lamp (1000 lux) for 10 minutes in such a manner that only the window part thereof could be subjected to environmental light exposure, whereby the electrophotographic photoreceptor is exposed to environmental light.

Next, the thus-exposed electrophotographic photoreceptor is mounted on an electrophotographic image forming apparatus (Versant 2100 Press manufactured by Fuji Xerox Co., Ltd.), and a full-page halftone image (cyan) having an image density of 50% is outputted on one sheet of A3-size paper to give one copy of the image.

Thus outputted, the full-page halftone image is observed, and the density difference between the part exposed to environmental light and the part not exposed to environmental light is visually determined for organoleptic evaluation (grade judgment). The grade judgment covers from 0G to 5G at intervals of 0.5G. In the test, the samples having a smaller numerical value G are to have a smaller density difference and therefore suffer from little optical fatigue. The acceptable grade of optical fatigue is 3.5G or less. In every case, image outputting is in an environment at 28° C. and 85% RH. The results are shown in Table 1 and Table 2.

### (Evaluation of Halftone Image Density)

The electrophotographic photoreceptor produced in each Example is mounted on an electrophotographic image forming apparatus (Versant 2100 Press manufactured by Fuji Xerox Co., Ltd.), and a full-page halftone image (cyan) having an image density of 50% is outputted on one sheet of A3-size paper to give one copy of the image.

Thus outputted, the full-page halftone image is observed and checked as to whether the intended image density could be outputted on the sheet. In every case, image outputting is in an environment at 28° C. and 85% RH. The results are shown in Table 1 and Table 2.

Examples and Comparative Examples, and also the evaluation results in those Examples are shown as tabulated records in Table 1 and Table 2. In Table 1 and Table 2, the column of “amount (% by weight)” of the antioxidant and the UV absorbent indicates the ratio thereof to 100% by weight of the total amount of all the charge-transporting materials in each Example.

TABLE 1

| | Charge-Transporting Material | | | | | | | | |
|---|---|---|---|---|---|---|---|---|---|
| | (CT1) | | (CT2) | | | Antioxidant | | | |
| | | Amount | | Amount | ratio by | | | Amount | |
| | Exemplified | (number of | Exemplified | (number of | weight of | Exemplified | Molecular | (number of | Amount |
| | Compound No. | parts) | Compound No. | parts) | CT1/CT2 | Compound No. | Weight | parts) | (% by weight) |
| Example 1-1 | CT1-1 | 8 | CT2-1 | 32 | 1/4 | HP-1 | 775 | 3.2 | 8 |
| Example 1-2 | CT1-1 | 8 | CT2-1 | 32 | 1/4 | HP-2 | 784 | 3.2 | 8 |
| Example 1-3 | CT1-2 | 8 | CT2-1 | 32 | 1/4 | HP-1 | 775 | 3.2 | 8 |
| Example 1-4 | CT1-2 | 8 | CT2-1 | 32 | 1/4 | HP-2 | 784 | 3.2 | 8 |
| Example 1-5 | CT1-1 | 8 | CT2-1 | 32 | 1/4 | none | — | 0 | 0 |
| Example 1-6 | CT1-1 | 8 | CT2-1 | 32 | 1/4 | none | — | 0 | 0 |
| Example 1-7 | CT1-2 | 8 | CT2-1 | 32 | 1/4 | none | — | 0 | 0 |
| Example 1-8 | CT1-2 | 8 | CT2-1 | 32 | 1/4 | none | — | 0 | 0 |
| Example 1-9 | CT1-1 | 8 | CT2-1 | 32 | 1/4 | HP-1 | 775 | 3.2 | 8 |
| Example 1-10 | CT1-1 | 8 | CT2-1 | 32 | 1/4 | HP-2 | 784 | 3.2 | 8 |
| Example 1-11 | CT1-3 | 8 | CT2-1 | 32 | 1/4 | HP-1 | 775 | 3.2 | 8 |
| Example 1-12 | CT1-3 | 8 | CT2-1 | 32 | 1/4 | none | — | 0 | 0 |
| Example 1-13 | CT1-3 | 8 | CT2-1 | 32 | 1/4 | HP-1 | 775 | 3.2 | 8 |
| Example 1-14 | CT1-3 | 8 | CT2-2 | 32 | 1/4 | HP-1 | 775 | 3.2 | 8 |
| Example 1-15 | CT1-3 | 8 | CT2-2 | 32 | 1/4 | none | — | 0 | 0 |
| Example 1-16 | CT1-3 | 8 | CT2-2 | 32 | 1/4 | HP-1 | 775 | 3.2 | 8 |
| Example 1-17 | CT1-3 | 8 | CT2-2 | 32 | 1/4 | HP-3 | 340 | 3.2 | 8 |
| Example 1-18 | CT1-3 | 8 | CT2-2 | 32 | 1/4 | HP-3 | 340 | 3.2 | 8 |
| Example 1-19 | CT1-3 | 8 | CT2-2 | 32 | 1/4 | HP-3 | 340 | 3.2 | 8 |
| Example 1-20 | CT1-3 | 8 | CT2-2 | 32 | 1/4 | HP-3 | 340 | 3.2 | 8 |
| Example 1-21 | CT1-3 | 8 | CT2-2 | 32 | 1/4 | HP-3 | 340 | 4.8 | 12 |
| Example 1-22 | CT1-3 | 8 | CT2-2 | 32 | 1/4 | HP-3 | 340 | 5.8 | 14.5 |
| Example 1-23 | CT1-3 | 8 | CT2-2 | 32 | 1/4 | HP-3 | 340 | 6.4 | 16 |
| Example 1-24 | CT1-3 | 8 | CT2-2 | 32 | 1/4 | HP-3 | 340 | 11.6 | 29 |
| Example 1-25 | CT1-3 | 8 | CT2-2 | 32 | 1/4 | HP-3 | 340 | 12.5 | 30.3 |
| Example 1-26 | CT1-3 | 16 | CT2-2 | 24 | 2/3 | HP-3 | 340 | 3.2 | 8 |
| Example 1-27 | CT1-3 | 20 | CT2-2 | 20 | 1/1 | HP-3 | 340 | 3.2 | 8 |
| Example 1-28 | CT1-3 | 24 | CT2-2 | 16 | 3/2 | HP-3 | 340 | 3.2 | 8 |
| Example 1-29 | CT1-3 | 4 | CT2-2 | 36 | 1/9 | HP-3 | 340 | 3.2 | 8 |
| Example 1-30 | CT1-3 | 24 | CT2-2 | 19 | 24/19 | HP-3 | 340 | 3.2 | 8 |
| Example 1-31 | CT1-3 | 36 | CT2-2 | 4 | 9/1 | HP-3 | 340 | 3.2 | 8 |

| | UV Absorbent | | | Evaluation | | |
|---|---|---|---|---|---|---|
| | Exemplified | Amount | Amount | Burn-in | Optical | |
| | Compound No. | (number of parts) | (% by weight) | Ghosting | Fatigue | Halftone Image density |
| Example 1-1 | none | 0 | 0 | 3.5 G | 3.5 G | good |
| Example 1-2 | none | 0 | 0 | 3.5 G | 3.5 G | good |
| Example 1-3 | none | 0 | 0 | 3.5 G | 3.5 G | good |
| Example 1-4 | none | 0 | 0 | 3.5 G | 3.5 G | good |
| Example 1-5 | BP-1 | 3.2 | 8 | 3.5 G | 3.5 G | good |
| Example 1-6 | BP-2 | 3.2 | 8 | 3.5 G | 3.5 G | good |
| Example 1-7 | BP-1 | 3.2 | 8 | 3.5 G | 3.5 G | good |
| Example 1-8 | BP-2 | 3.2 | 8 | 3.5 G | 3.5 G | good |
| Example 1-9 | BP-1 | 3.2 | 8 | 3.0 G | 2.5 G | good |
| Example 1-10 | BP-2 | 3.2 | 8 | 3.0 G | 3.0 G | good |
| Example 1-11 | none | 0 | 0 | 3.0 G | 2.5 G | good |
| Example 1-12 | BP-1 | 3.2 | 8 | 2.5 G | 3.0 G | good |
| Example 1-13 | BP-1 | 3.2 | 8 | 2.5 G | 2.5 G | good |
| Example 1-14 | none | 0 | 0 | 2.0 G | 2.0 G | good |
| Example 1-15 | BP-1 | 3.2 | 8 | 2.0 G | 2.0 G | good |
| Example 1-16 | BP-1 | 3.2 | 8 | 1.5 G | 1.5 G | good |
| Example 1-17 | none | 0 | 0 | 1.5 G | 1.5 G | good |
| Example 1-18 | BP-1 | 3.2 | 8 | 1.0 G | 1.0 G | good |
| Example 1-19 | none | 0 | 0 | 0.5 G | 0.5 G | good |
| Example 1-20 | BP-3 | 3.2 | 8 | 0 G | 0 G | good |
| Example 1-21 | BP-3 | 4.8 | 12 | 0 G | 0 G | slightly pale |
| Example 1-22 | BP-3 | 5.8 | 14.5 | 0 G | 0 G | slightly pale |
| Example 1-23 | BP-3 | 6.4 | 16 | 0 G | 0 G | somewhat pale |
| Example 1-24 | BP-3 | 11.6 | 29 | 0 G | 0 G | somewhat pale |
| Example 1-25 | BP-3 | 12.5 | 30.3 | 0 G | 0 G | pale |
| Example 1-26 | BP-3 | 3.2 | 8 | 0 G | 0 G | good |
| Example 1-27 | BP-3 | 3.2 | 8 | 1.0 G | 1.0 G | good |
| Example 1-28 | BP-3 | 3.2 | 8 | 1.0 G | 1.0 G | good |
| Example 1-29 | BP-3 | 3.2 | 8 | 0 G | 0 G | somewhat pale |
| Example 1-30 | BP-3 | 3.2 | 8 | 2.0 G | 2.0 G | good |
| Example 1-31 | BP-3 | 3.2 | 8 | 3.0 G | 3.0 G | good |

TABLE 2

| | Charge-Transporting Material | | | | | | | | |
|---|---|---|---|---|---|---|---|---|---|
| | (CT1) | | (CT2) | | | Antioxidant | | | |
| | | Amount | | Amount | ratio by | | | Amount | |
| | Exemplified | (number of | Exemplified | (number of | weight of | Exemplified | Molecular | (number of | Amount |
| | Compound No. | parts) | Compound No. | parts) | CT1/CT2 | Compound No. | Weigth | parts) | (% by weight) |
| Comparative | CT1-3 | 8 | CT2-2 | 32 | 1/4 | none | — | 0 | 0 |
| Example 1-1 | | | | | | | | | |
| Comparative | none | 0 | CT2-2 | 32 | 0/32 | HP-3 | 340 | 3.2 | 8 |
| Example 1-2 | | | | | | | | | |
| Comparative | CT1-3 | 8 | CT2-2 | 32 | 1/4 | CAO-1 | 220 | 3.2 | 8 |
| Example 1-3 | | | | | | | | | |
| Comparative | CT1-3 | 8 | CT2-2 | 32 | 1/4 | none | — | 0 | 0 |
| Example 1-4 | | | | | | | | | |
| Comparative | CT1-3 | 8 | CT2-2 | 32 | 1/4 | CAO-1 | 220 | 3.2 | 8 |
| Example 1-5 | | | | | | | | | |
| Comparative | CT1-3 | 8 | CT2-2 | 32 | 1/4 | CAO-2 | — | 3.2 | 8 |
| Example 1-6 | | | | | | | | | |

| | UV Absorbent | | | Evaluation | | |
|---|---|---|---|---|---|---|
| | Exemplified | Amount | Amount | | | Halftone Image |
| | Compound No. | (number of parts) | (% by weight) | Burn-in Ghosting | Optical Fatigue | density |
| Comparative | none | 0 | 0 | 5.0 G | 5.0 G | good |
| Example 1-1 | | | | | | |
| Comparative | BP-3 | 3.2 | 8 | undeterminable | undeterminable | density |
| Example 1-2 | | | | | | insufficiency |
| Comparative | none | 0 | 0 | 5.0 G | 5.0 G | good |
| Example 1-3 | | | | | | |
| Comparative | CUA-1 | 3.2 | 8 | 5.0 G | 5.0 G | good |
| Example 1-4 | | | | | | |
| Comparative | CUA-1 | 3.2 | 8 | 5.0 G | 4.5 G | good |
| Example 1-5 | | | | | | |
| Comparative | none | 0 | 0 | 5.0 G | 5.0 G | good |
| Example 1-6 | | | | | | |

From the above results, it is known that in Examples 1-1 to 1-31, the troubles of “burn-in ghosting” and “optical fatigue” are prevented as compared with those in Comparative Examples 1-1 to 1-6.

In addition, it is known that, in Examples 1-1 to 1-20 where the compounding amount of the hindered amine antioxidant and that of the benzophenone UV absorbent are suitable, the intended halftone image density is obtained as compared with that in Examples 1-21 to 1-25.

### Example 2-1

100 parts by weight of zinc oxide (trade name: MZ 300, by TAYCA Corporation), 10 parts by weight of a toluene solution of 10%/o by weight of a silane coupling agent, N-2-(aminoethyl)-3-aminopropyltriethoxysilane, and 200 parts by weight of toluene are mixed, stirred and refluxed for 2 hours. Subsequently, toluene is evaporated away under a reduced pressure of 10 mmHg, and the residue is baked at 135° C. for 2 hours for surface treatment of zinc oxide with the silane coupling agent.

33 parts by weight of the surface-treated zinc oxide, 6 parts by weight of a blocked isocyanate (trade name: Sumidur 3175, by Sumitomo Bayer Urethane Corporation), 1 part by weight of a compound represented by the following structural formula (AK-1), and 25 parts by weight of methyl ethyl ketone are mixed for 30 minutes, and then 5 parts by weight of a butyral resin (trade name: S-LEC BM-1, by SEKISUI CHEMICAL CO., LTD.), 3 parts by weight of silicon balls (trade name: Tospearl 120, by Momentive Performance Materials Inc.), and 0.01 parts by weight of a leveling agent of silicone oil (trade name: SH29PA, by Toray Dow Corning Corporation) are added thereto, and dispersed with a sand mill for 3 hours to prepare an undercoat layer-forming coating liquid.

According to a dip coating method, the underlayer-forming coating liquid is applied onto an aluminum substrate having a diameter of 47 mm, a length of 357 mm and a thickness of 1 mm, and dried and cured at 180° C. for 30 minutes to form thereon an undercoat layer having a thickness of 25 μm.

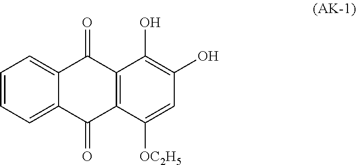 [SMILES: CCOc1cc(O)c(O)c2c1C(=O)c1ccccc1C2=O]

Next, a mixture containing a charge-generating material of hydroxygallium phthalocyanine pigment “V-type hydroxygallium phthalocyanine pigment having, in the X-ray diffraction spectrum thereof using a CuKα characteristic X ray, diffraction peaks at the Bragg angle (2θ±0.2°) of at least 7.3°, 16.0°, 24.9° and 28.0° (maximum peak wavelength in the spectral absorption spectrum in a wavelength of from 600 nm to 900 nm=820 nm, mean particle size=0.12 μm, maximum particle size=0.2 μm, specific surface area value=60 m²/g)”, a binder resin of vinyl chloride-vinyl acetate copolymer resin (trade name: VMCH, by NUC Corporation), and n-butyl acetate is put into a 100-mL glass bottle along with 1.0 mmφ glass beads at a filling rate of 50%, and dispersed for 2.5 hours using a paint shaker to prepare a charge generation layer-forming coating liquid. The content of hydroxygallium phthalocyanine pigment relative to the mixture of hydroxygallium phthalocyanine pigment and vinyl chloride-vinyl acetate copolymer resin is 55.0% by volume, and the solid content of the dispersion is 6.0% by weight. In calculating the content, the specific gravity of hydroxygallium phthalocyanine pigment is 1.606 g/cm³, and the specific gravity of vinyl chloride-vinyl acetate copolymer resin is 1.35 g/cm³.

Thus prepared, the charge generation layer-forming coating liquid is applied onto the undercoat layer in a mode of dip coating, and dried at 100° C. for 5 minutes to form a charge generation layer having a thickness of 0.20 μm.

Next, as charge-transporting materials, 8.0 parts by weight of a butadiene charge-transporting material (CT1) “exemplified compound (CT1-1) and 32.0 parts by weight of a benzidine charge-transporting material (CT2) “exemplified compound (CT2-1); as a binder resin, 60.0 parts by weight of a BP polycarbonate resin “exemplified compound (PC-1), pm/pn=25/74, viscosity-average molecular weight=50,000”; as fluorine-containing resin particles, 8 parts by weight of tetrafluoroethylene resin particles (volume-average particle size 200 nm); as a fluorine-containing dispersant, 0.3 parts by weight of GF400 (by TOAGOSEI CO., LTD, surfactant containing at least a fluoroalkyl group-having methacrylate as the polymerization component therein); and as an antioxidant, 3.2 parts by weight of a hindered phenol antioxidant “exemplified compound (HP-1), having a molecular weight of 775” (8.0% by weight relative to 100% by weight of the total amount of all the charge-transporting materials) are added and dissolved in 340.0 parts by weight of tetrahydrofuran to prepare a charge transport layer-forming coating liquid.

The resultant, charge transport layer-forming coating liquid is applied onto the charge generation layer in a mode of dip coating, and dried at 150° C. for 40 minutes to form thereon a charge transport layer having a thickness of 34 μm.

According to the above-mentioned process, an electrophotographic photoreceptor is produced.

### Examples 2-2 to 2-4

Electrophotographic photoreceptors are produced in the same manner as in Example 2-1 except that the type of the charge-transporting materials and the type of the hindered phenol antioxidant are changed as in Table 3.

### Example 2-5

An electrophotographic photoreceptor is produced in the same manner as in Example 2-1 except that, in place of the hindered phenol antioxidant which is an antioxidant, 3.2 parts by weight of a benzophenone UV absorbent “exemplified compound (BP-1)” (8.0% by weight relative to 100% by weight of the total amount of all the charge-transporting materials) is used.

### Examples 2-6 to 2-8

Electrophotographic photoreceptors are produced in the same manner as in Example 2-5 except that the type of the charge-transporting materials and the type of the benzophenone UV absorbent are changed as in Table 3.

### Example 2-9

An electrophotographic photoreceptor is produced in the same manner as in Example 2-1 except that 3.2 parts by weight of a hindered phenol antioxidant “exemplified compound (HP-1), having a molecular weight of 775” (8.0% by weight relative to 100% by weight of the total amount of all the charge-transporting materials) and 3.2 parts by weight of a benzophenone UV absorbent “exemplified compound (BP-1)” (8.0% by weight relative to 100% by weight of the total amount of all the charge-transporting materials) are used.

### Example 2-10

An electrophotographic photoreceptor is produced in the same manner as in Example 2-9 except that the type of the hindered phenol antioxidant and the type of the benzophenone UV absorbent are changed as in Table 3.

### Examples 2-11 to 2-20

Electrophotographic photoreceptors are produced in the same manner as in Example 2-9 except that the type of the charge-transporting materials, the type of the hindered phenol antioxidant and the type of the benzophenone UV absorbent are changed as in Table 3.

### Examples 2-21 to 2-25

Electrophotographic photoreceptors are produced in the same manner as in Example 2-20 except that the amount of the hindered phenol antioxidant which is an antioxidant and the amount of the benzophenone UV absorbent which is an UV absorbent are changed as in Table 3.

### Examples 2-26 to 2-31

Electrophotographic photoreceptors are produced in the same manner as in Example 2-20 except that the amount of the charge-transporting materials is changed as in Table 3.

### Example 2-32

An electrophotographic photoreceptor is produced in the same manner as in Example 2-1 except that, as the BP polycarbonate resin, the exemplified compound (PC-2) (pm/pn=25/75) is used.

### Example 2-33

An electrophotographic photoreceptor is produced in the same manner as in Example 2-1 except that, as the BP polycarbonate resin, the exemplified compound (PC-3) (pm/pn=25/75) is used.

### Example 2-34

An electrophotographic photoreceptor is produced in the same manner as in Example 2-1 except that the fluorine-containing resin particles and the fluorine-containing dispersant are not used.

### Comparative Examples 2-1 to 2-6

Electrophotographic photoreceptors are produced in the same manner as in Example 2-9 except that the type of the charge-transporting materials, the type of the antioxidant and the type of the UV absorbent are changed as in Table 4.

### Comparative Example 2-71

An electrophotographic photoreceptor is produced in the same manner as in Comparative Example 2-1 except that, in place of the BP polycarbonate resin, 60.0 parts by weight of PCZ500 “bisphenol Z-type polycarbonate resin (bisphenol Z homopolymer-type polycarbonate resin, having a viscosity-average molecular weight of 50,000)” is used.

### Evaluation

The electrophotographic photoreceptors produced in Examples are evaluated in point of “burn-in ghosting”, “optical fatigue”, “halftone image density” and “abrasion resistance” therein, according to the manner described below.

### (Evaluation of Burn-in Ghosting)

The electrophotographic photoreceptor produced in each Example is mounted on an electrophotographic image forming apparatus (Versant 2100 Press manufactured by Fuji Xerox Co., Ltd.), a lattice pattern chart is continuously outputted on 3000 sheets of A3-size paper to give 3000 copies of the pattern chart, and thereafter a full-page halftone image (a full-page halftone image of cyan color) having an image density of 20% is outputted on one sheet of A3-size paper to give one copy of the image.

Thus outputted, the full-page halftone image is observed, and the density difference between the continuous image-outputted part and the discontinuous image-outputted part of the lattice pattern is visually determined for organoleptic evaluation (grade judgment). The grade judgment covers from 0G to 5G at intervals of 0.5G. In the test, the samples having a smaller numerical value G are to have a smaller density difference and therefore suffer from little burn-in ghosting. The acceptable grade of burn-in ghosting is 3.5G or less. In every case, image outputting is in an environment at 28° C. and 85% RH. The results are shown in Table 3 and Table 4.

### (Evaluation of Optical Fatigue)

First, the electrophotographic photoreceptor produced in each Example is wound around a black paper having a 2-cm square window formed therein, and left under a white fluorescent lamp (1000 lux) for 10 minutes in such a manner that only the window part thereof could be subjected to environmental light exposure, whereby the electrophotographic photoreceptor is exposed to environmental light.

Next, the thus-exposed electrophotographic photoreceptor is mounted on an electrophotographic image forming apparatus (Versant 2100 Press manufactured by Fuji Xerox Co., Ltd.), and a full-page halftone image (cyan) having an image density of 50% is outputted on one sheet of A3-size paper to give one copy of the image.

Thus outputted, the full-page halftone image is observed, and the density difference between the part exposed to environmental light and the part not exposed to environmental light is visually determined for organoleptic evaluation (grade judgment). The grade judgment covers from 0G to 5G at intervals of 0.5G. In the test, the samples having a smaller numerical value G are to have a smaller density difference and therefore suffer from little optical fatigue. The acceptable grade of optical fatigue is 3.5G or less. In every case, image outputting is in an environment at 28° C. and 85% RH. The results are shown in Table 3 and Table 4.

### (Evaluation of Halftone Image Density)

The electrophotographic photoreceptor produced in each Example is mounted on an electrophotographic image forming apparatus (Versant 2100 Press manufactured by Fuji Xerox Co., Ltd.), and a full-page halftone image (cyan) having an image density of 50% is outputted on one sheet of A3-size paper to give one copy of the image.

Thus outputted, the full-page halftone image is observed and checked as to whether the intended image density could be outputted on the sheet. In every case, image outputting is in an environment at 28° C. and 85% RH. The results are shown in Table 3 and Table 4.

### (Evaluation of Abrasion Resistance)

The electrophotographic photoreceptor produced in each Example is mounted on an electrophotographic image forming apparatus (Versant 2100 Press manufactured by Fuji Xerox Co., Ltd.), and a chart having an image density of 5% is continuously outputted on 200000 sheets of A4-size paper to give 200000 copies of the chart, and thereafter the thickness of the photosensitive layer of the photoreceptor is measured. For measuring the thickness of the photosensitive layer, used is an eddy-current film thickness measuring instrument (by Fischer instruments K.K.). Before and after continuous outputting to give 200000, the difference in the thickness of the photosensitive layer (μm) is determined. The results are shown in Table 3 and Table 4.

Examples and Comparative Examples, and also the evaluation results in those Examples are shown as tabulated records in Table 3 and Table 4. In Table 3 and Table 4, the column of “amount (% by weight)” of the antioxidant and the UV absorbent indicates the ratio thereof to 100% by weight of the total amount of all the charge-transporting materials in each Example.

TABLE 3

| | Charge-Transporting Material | | | | | | | | | | |
|---|---|---|---|---|---|---|---|---|---|---|---|
| | (CT1) | | (CT2) | | | | | Binder Resin | | Flourine- | |
| | | Amount | | Amount | | ratio by | | Exemplified | | Containing | Flourine- |
| | Exemplified | (number | Exemplified | (number | | weight of | | Compound | | Resin | Containing |
| | Compound | of parts) | Compound | of parts) | | CT1/CT2 | | No. | pm/pn | Particles | Dispersant |
| Example 2-1 | CT1-1 | 8 | CT2-1 | 32 | | 1/4 | | PC-1 | 25/75 | yes | yes |
| Example 2-2 | CT1-1 | 8 | CT2-1 | 32 | | 1/4 | | PC-1 | 25/75 | yes | yes |
| Example 2-3 | CT1-2 | 8 | CT2-1 | 32 | | 1/4 | | PC-1 | 25/75 | yes | yes |
| Example 2-4 | CT1-2 | 8 | CT2-1 | 32 | | 1/4 | | PC-1 | 25/75 | yes | yes |
| Example 2-5 | CT1-1 | 8 | CT2-1 | 32 | | 1/4 | | PC-1 | 25/75 | yes | yes |
| Example 2-6 | CT1-1 | 8 | CT2-1 | 32 | | 1/4 | | PC-1 | 25/75 | yes | yes |
| Example 2-7 | CT1-2 | 8 | CT2-1 | 32 | | 1/4 | | PC-1 | 25/75 | yes | yes |
| Example 2-8 | CT1-2 | 8 | CT2-1 | 32 | | 1/4 | | PC-1 | 25/75 | yes | yes |
| Example 2-9 | CT1-1 | 8 | CT2-1 | 32 | | 1/4 | | PC-1 | 25/75 | yes | yes |
| Example 2-10 | CT1-1 | 8 | CT2-1 | 32 | | 1/4 | | PC-1 | 25/75 | yes | yes |
| Example 2-11 | CT1-3 | 8 | CT2-1 | 32 | | 1/4 | | PC-1 | 25/75 | yes | yes |
| Example 2-12 | CT1-3 | 8 | CT2-1 | 32 | | 1/4 | | PC-1 | 25/75 | yes | yes |
| Example 2-13 | CT1-3 | 8 | CT2-1 | 32 | | 1/4 | | PC-1 | 25/75 | yes | yes |
| Example 2-14 | CT1-3 | 8 | CT2-2 | 32 | | 1/4 | | PC-1 | 25/75 | yes | yes |
| Example 2-15 | CT1-3 | 8 | CT2-2 | 32 | | 1/4 | | PC-1 | 25/75 | yes | yes |
| Example 2-16 | CT1-3 | 8 | CT2-2 | 32 | | 1/4 | | PC-1 | 25/75 | yes | yes |
| Example 2-17 | CT1-3 | 8 | CT2-2 | 32 | | 1/4 | | PC-1 | 25/75 | yes | yes |
| Example 2-18 | CT1-3 | 8 | CT2-2 | 32 | | 1/4 | | PC-1 | 25/75 | yes | yes |
| Example 2-19 | CT1-3 | 8 | CT2-2 | 32 | | 1/4 | | PC-1 | 25/75 | yes | yes |
| Example 2-20 | CT1-3 | 8 | CT2-2 | 32 | | 1/4 | | PC-1 | 25/75 | yes | yes |
| Example 2-21 | CT1-3 | 8 | CT2-2 | 32 | | 1/4 | | PC-1 | 25/75 | yes | yes |
| Example 2-22 | CT1-3 | 8 | CT2-2 | 32 | | 1/4 | | PC-1 | 25/75 | yes | yes |
| Example 2-23 | CT1-3 | 8 | CT2-2 | 32 | | 1/4 | | PC-1 | 25/75 | yes | yes |
| Example 2-24 | CT1-3 | 8 | CT2-2 | 32 | | 1/4 | | PC-1 | 25/75 | yes | yes |
| Example 2-25 | CT1-3 | 8 | CT2-2 | 32 | | 1/4 | | PC-1 | 25/75 | yes | yes |
| Example 2-26 | CT1-3 | 16 | CT2-2 | 24 | | 2/3 | | PC-1 | 25/75 | yes | yes |
| Example 2-27 | CT1-3 | 20 | CT2-2 | 20 | | 1/1 | | PC-1 | 25/75 | yes | yes |
| Example 2-28 | CT1-3 | 24 | CT2-2 | 16 | | 3/2 | | PC-1 | 25/75 | yes | yes |
| Example 2-29 | CT1-3 | 4 | CT2-2 | 36 | | 1/9 | | PC-1 | 25/75 | yes | yes |
| Example 2-30 | CT1-3 | 24 | CT2-2 | 19 | | 24/19 | | PC-1 | 25/75 | yes | yes |
| Example 2-31 | CT1-3 | 36 | CT2-2 | 4 | | 9/1 | | PC-1 | 25/75 | yes | yes |
| Example 2-32 | CT1-1 | 8 | CT2-1 | 32 | | 1/4 | | PC-2 | 25/75 | yes | yes |
| Example 2-33 | CT1-1 | 8 | CT2-1 | 32 | | 1/4 | | PC-3 | 25/75 | yes | yes |
| Example 2-34 | CT1-1 | 8 | CT2-1 | 32 | | 1/4 | | PC-1 | 25/75 | no | no |
| | Antioxidant | | | | UV Absorbent | | | Evaluation | | | |
| | Exemplified | Mo- | Amount | | Exemplified | Amount | | | | Halftone | |
| | Compound | lecular | (number | Amount | Compound | (number | Amount | Burn-in | Optical | Image | Abrasion |
| | No. | Weight | of parts) | (wt %) | No. | of parts) | (wt %) | Ghosting | Fatigue | density | Resistance |
| Example 2-1 | HP-1 | 775 | 3.2 | 8 | none | 0 | 0 | 3.5 G | 3.5 G | good | 1.2 μm |
| Example 2-2 | HP-2 | 784 | 3.2 | 8 | none | 0 | 0 | 3.5 G | 3.5 G | good | 1.2 μm |
| Example 2-3 | HP-1 | 775 | 3.2 | 8 | none | 0 | 0 | 3.5 G | 3.5 G | good | 1.2 μm |
| Example 2-4 | HP-2 | 784 | 3.2 | 8 | none | 0 | 0 | 3.5 G | 3.5 G | good | 1.2 μm |
| Example 2-5 | none | — | — | 0 | BP-1 | 3.2 | 8 | 3.5 G | 3.5 G | good | 1.1 μm |
| Example 2-6 | none | — | — | 0 | BP-2 | 3.2 | 8 | 3.5 G | 3.5 G | good | 1.1 μm |
| Example 2-7 | none | — | — | 0 | BP-1 | 3.2 | 8 | 3.5 G | 3.5 G | good | 1.1 μm |
| Example 2-8 | none | — | — | 0 | BP-2 | 3.2 | 8 | 3.5 G | 3.5 G | good | 1.1 μm |
| Example 2-9 | HP-1 | 775 | 3.2 | 8 | BP-1 | 3.2 | 8 | 3.5 G | 3 G | good | 1.2 μm |
| Example 2-10 | HP-2 | 784 | 3.2 | 8 | BP-2 | 3.2 | 8 | 3.5 G | 3.5 G | good | 1.2 μm |
| Example 2-11 | HP-1 | 775 | 3.2 | 8 | none | 0 | 0 | 3.5 G | 3 G | good | 1.2 μm |
| Example 2-12 | none | — | 0 | 0 | BP-1 | 3.2 | 8 | 3.0 G | 3.5 G | good | 1.1 μm |
| Example 2-13 | HP-1 | 775 | 3.2 | 8 | BP-1 | 3.2 | 8 | 3.0 G | 3 G | good | 1.2 μm |
| Example 2-14 | HP-1 | 775 | 3.2 | 8 | none | 0 | 0 | 2.5 G | 2.5 G | good | 1.2 μm |
| Example 2-15 | none | — | 0 | 0 | BP-1 | 3.2 | 8 | 2.5 G | 2.5 G | good | 1.1 μm |
| Example 2-16 | HP-1 | 775 | 3.2 | 8 | BP-1 | 3.2 | 8 | 2.0 G | 2 G | good | 1.2 μm |
| Example 2-17 | HP-3 | 340 | 3.2 | 8 | none | 0 | 0 | 2.0 G | 2 G | good | 1.2 μm |
| Example 2-18 | HP-3 | 340 | 3.2 | 8 | BP-1 | 3.2 | 8 | 1.5 G | 1.5 G | good | 1.2 μm |
| Example 2-19 | HP-3 | 340 | 3.2 | 8 | none | 0 | 0 | 1.0 G | 1.0 G | good | 1.2 μm |
| Example 2-20 | HP-3 | 340 | 3.2 | 8 | BP-3 | 3.2 | 8 | 0.5 G | 0.5 G | good | 1.2 μm |
| Example 2-21 | HP-3 | 340 | 4.8 | 12 | BP-3 | 4.8 | 12 | 0.5 G | 0.5 G | slightly pale | 1.2 μm |
| Example 2-22 | HP-3 | 340 | 5.8 | 14.5 | BP-3 | 5.8 | 14.5 | 0.5 G | 0.5 G | slightly pale | 1.2 μm |
| Example 2-23 | HP-3 | 340 | 6.4 | 16 | BP-3 | 6.4 | 16 | 0.5 G | 0.5 G | somewhat | 1.2 μm |
| | | | | | | | | | | pale | |
| Example 2-24 | HP-3 | 340 | 11.6 | 28.9 | BP-3 | 11.6 | 28.9 | 0.5 G | 0.5 G | somewhat | 1.2 μm |
| | | | | | | | | | | pale | |
| Example 2-25 | HP-3 | 340 | 12 | 30.1 | BP-3 | 12 | 30.1 | 0.5 G | 0.5 G | pale | 1.2 μm |
| Example 2-26 | HP-3 | 340 | 3.2 | 8 | BP-3 | 3.2 | 8 | 0 G | 0 G | good | 1.2 μm |
| Example 2-27 | HP-3 | 340 | 3.2 | 8 | BP-3 | 3.2 | 8 | 1.0 G | 1.0 G | good | 1.2 μm |
| Example 2-28 | HP-3 | 340 | 3.2 | 8 | BP-3 | 3.2 | 8 | 1.0 G | 1.0 G | good | 1.2 μm |
| Example 2-29 | HP-3 | 340 | 3.2 | 8 | BP-3 | 3.2 | 8 | 0 G | 0 G | somewhat | 1.2 μm |
| | | | | | | | | | | pale | |
| Example 2-30 | HP-3 | 340 | 3.2 | 8 | BP-3 | 3.2 | 8 | 2.0 G | 2.0 G | good | 1.2 μm |
| Example 2-31 | HP-3 | 340 | 3.2 | 8 | BP-3 | 3.2 | 8 | 3.0 G | 3.0 G | good | 1.2 μm |
| Example 2-32 | HP-1 | 775 | 3.2 | 8 | none | 0 | 0 | 3.5 G | 3.5 G | good | 1.4 μm |
| Example 2-33 | HP-1 | 775 | 3.2 | 8 | none | 0 | 0 | 3.5 G | 3.5 G | good | 2.0 μm |
| Example 2-34 | HP-1 | 775 | 3.2 | 8 | none | 0 | 0 | 3.5 G | 3 G | good | 4.5 μm |

TABLE 4

| | Charge-Transporting Material | | | | | | | | | |
|---|---|---|---|---|---|---|---|---|---|---|
| | (CT1) | | (CT2) | | Binder Resin | | Antioxidant | | | |
| | Exemplified | Amount | Exemplified | Amount | Exemplified | | Exemplified | | Amount | Amount |
| | Compound | (number | Compound | (number of | Compound | | Compound | Molecular | (number | (% by |
| | No. | of parts) | No. | parts) | No. | pm/pn | No. | Weight | of parts) | weight) |
| Comparative | CT1-3 | 8 | CT2-2 | 32 | PC-1 | 25/75 | none | — | 0 | 0 |
| Example 2-1 | | | | | | | | | | |
| Comparative | none | 8 | CT2-2 | 32 | PC-1 | 25/75 | HP-3 | 340 | 3.2 | 8 |
| Example 2-2 | | | | | | | | | | |
| Comparative | CT1-3 | 8 | CT2-2 | 32 | PC-1 | 25/75 | CAO-1 | 220 | 3.2 | 8 |
| Example 2-3 | | | | | | | | | | |
| Comparative | CT1-3 | 8 | CT2-2 | 32 | PC-1 | 25/75 | none | — | 0 | 0 |
| Example 2-4 | | | | | | | | | | |
| Comparative | CT1-3 | 8 | CT2-2 | 32 | PC-1 | 25/75 | CAO-1 | 220 | 3.2 | 8 |
| Example 2-5 | | | | | | | | | | |
| Comparative | CT1-3 | 8 | CT2-2 | 32 | PC-1 | 25/75 | CAO-2 | — | 3.2 | 8 |
| Example 2-6 | | | | | | | | | | |
| Comparative | CT1-3 | 8 | CT2-2 | 32 | PCZ500 | — | none | — | 0 | 0 |
| Example 2-7 | | | | | | | | | | |

UV Absorbent

| | Exemplified | Amount | Amount | Evaluation | | | |
|---|---|---|---|---|---|---|---|
| | Compound | (number | (% by | Burn-in | | Halftone Image | Abrasion |
| | No. | of parts) | weight) | Ghosting | Optical Fatigue | density | Resistance |
| Comparative | none | 0 | 0 | 5.0 G | 5.0 G | good | 1.1 μm |
| Example 2-1 | | | | | | | |
| Comparative | BP-3 | 3.2 | 8 | undeterminable | undeterminable | density insufficiency | 1.0 μm |
| Example 2-2 | | | | | | | |
| Comparative | none | 0 | 0 | 5.0 G | 5.0 G | good | 1.2 μm |
| Example 2-3 | | | | | | | |
| Comparative | CUA-1 | 3.2 | 8 | 5.0 G | 5.0 G | good | 1.1 μm |
| Example 2-4 | | | | | | | |
| Comparative | CUA-1 | 3.2 | 8 | 5.0 G | 5.0 G | good | 1.2 μm |
| Example 2-5 | | | | | | | |
| Comparative | none | 0 | 0 | 5.0 G | 5.0 G | good | 1.2 μm |
| Example 2-6 | | | | | | | |
| Comparative | none | 0 | 0 | 3.5G | 5.0 G | good | 3.0 μm |
| Example 2-7 | | | | | | | |

From the above results, it is known that in Examples 2-1 to 2-34, the troubles of “burn-in ghosting” and “optical fatigue” are prevented as compared with those in Comparative Examples 2-1 to 2-7.

In addition, it is known that, in Examples 2-1 to 2-20 where the compounding amount of the hindered phenol antioxidant and that of the benzophenone UV absorbent are suitable, the intended halftone image density is obtained as compared with that in Examples 2-21 to 2-25.

### Example 3-1

100 parts by weight of zinc oxide (trade name: MZ 300, by TAYCA Corporation), 10 parts by weight of a toluene solution of 10% by weight of a silane coupling agent, N-2-(aminoethyl)-3-aminopropyltriethoxysilane, and 200 parts by weight of toluene are mixed, stirred and refluxed for 2 hours. Subsequently, toluene is evaporated away under a reduced pressure of 10 mmHg, and the residue is baked at 135° C. for 2 hours for surface treatment of zinc oxide with the silane coupling agent.

33 parts by weight of the surface-treated zinc oxide, 6 parts by weight of a blocked isocyanate (trade name: Sumidur 3175, by Sumitomo Bayer Urethane Corporation), 1 part by weight of a compound represented by the following structural formula (AK-1), and 25 parts by weight of methyl ethyl ketone are mixed for 30 minutes, and then 5 parts by weight of a butyral resin (trade name: S-LEC BM-1, by SEKISUI CHEMICAL CO., LIT.), 3 parts by weight of silicon balls (trade name: Tospearl 120, by Momentive Performance Materials Inc.), and 0.01 parts by weight of a leveling agent of silicone oil (trade name: SH29PA, by Toray Dow Corning Corporation) are added thereto, and dispersed with a sand mill for 3 hours to prepare an undercoat layer-forming coating liquid.

According to a dip coating method, the underlayer-forming coating liquid is applied onto an aluminum substrate having a diameter of 47 mm, a length of 357 mm and a thickness of 1 mm, and dried and cured at 180° C. for 30 minutes to form thereon an undercoat layer having a thickness of 25 μm.

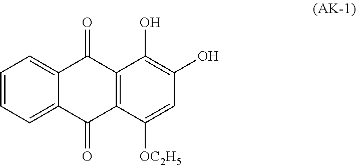 [SMILES: CCOc1cc(O)c(O)c2c1C(=O)c1ccccc1C2=O]

Next, a mixture containing a charge-generating material of hydroxygallium phthalocyanine pigment “V-type hydroxygallium phthalocyanine pigment having, in the X-ray diffraction spectrum thereof using a CuKα characteristic X ray, diffraction peaks at the Bragg angle (2θ±0.2°) of at least 7.3°, 16.0°, 24.9° and 28.0° (maximum peak wavelength in the spectral absorption spectrum in a wavelength of from 600 nm to 900 nm=820 nm, mean particle size=0.12 μm, maximum particle size=0.2 μm, specific surface area value=60 m²/g)”, a binder resin of vinyl chloride-vinyl acetate copolymer resin (trade name: VMCH, by NUC Corporation), and n-butyl acetate is put into a 100-mL glass bottle along with 1.0 mmφ glass beads at a filling rate of 50%, and dispersed for 2.5 hours using a paint shaker to prepare a charge generation layer-forming coating liquid. The content of hydroxygallium phthalocyanine pigment relative to the mixture of hydroxygallium phthalocyanine pigment and vinyl chloride-vinyl acetate copolymer resin is 55.0% by volume, and the solid content of the dispersion is 6.0% by weight. In calculating the content, the specific gravity of hydroxygallium phthalocyanine pigment is 1.606 g/cm³, and the specific gravity of vinyl chloride-vinyl acetate copolymer resin is 1.35 g/cm³.

Thus prepared, the charge generation layer-forming coating liquid is applied onto the undercoat layer in a mode of dip coating, and dried at 100° C. for 5 minutes to form a charge generation layer having a thickness of 0.20 μm.

Next, as charge-transporting materials, 8.0 parts by weight of a butadiene charge-transporting material (CT1) “exemplified compound (CT1-1) and 32.0 parts by weight of a benzidine charge-transporting material (CT2) “exemplified compound (CT2-1); as a binder resin, 60.0 parts by weight of a bisphenol Z-type polycarbonate resin (bisphenol Z homopolymer-type polycarbonate, having a viscosity-average molecular weight of 40,000); as fluorine-containing resin particles, 8 parts by weight of tetrafluoroethylene resin particles (volume-average particle size 200 nm); as a fluorine-containing dispersant, 0.24 parts by weight of GF400 (by TOAGOSEI CO., LTD.); and as an antioxidant, 3.2 parts by weight of a hindered phenol antioxidant “exemplified compound (HP-1), having a molecular weight of 775” (8.0% by weight relative to 100% by weight of the total amount of all the charge-transporting materials) are added and dissolved in 340 parts by weight of tetrahydrofuran to prepare a charge transport layer-forming coating liquid.

The resultant, charge transport layer-forming coating liquid is applied onto the charge generation layer in a mode of dip coating, and dried at 150° C. for 40 minutes to form thereon a charge transport layer having a thickness of 34 μm.

According to the above-mentioned process, an electrophotographic photoreceptor is produced.

### Examples 3-2 to 3-4

Electrophotographic photoreceptors are produced in the same manner as in Example 3-1 except that the type of the charge-transporting materials and the type of the hindered phenol antioxidant are changed as in Table 5.

### Example 3-5

An electrophotographic photoreceptor is produced in the same manner as in Example 3-1 except that, in place of the hindered phenol antioxidant which is an antioxidant, 3.2 parts by weight of a benzophenone UV absorbent “exemplified compound (BP-1)” (8.0% by weight relative to 100% by weight of the total amount of all the charge-transporting materials) is used.

### Examples 3-6 to 3-8

Electrophotographic photoreceptors are produced in the same manner as in Example 3-5 except that the type of the charge-transporting materials and the type of the benzophenone UV absorbent are changed as in Table 5.

### Example 3-9

An electrophotographic photoreceptor is produced in the same manner as in Example 3-1 except that 3.2 parts by weight of a hindered phenol antioxidant “exemplified compound (HP-1), having a molecular weight of 775” (8.0% by weight relative to 100% by weight of the total amount of all the charge-transporting materials) and further 3.2 parts by weight of a benzophenone UV absorbent as a UV absorbent “exemplified compound (BP-1)” (8.0% by weight relative to 100% by weight of the total amount of all the charge-transporting materials) are used.

### Example 3-10

An electrophotographic photoreceptor is produced in the same manner as in Example 3-9 except that the type of the hindered phenol antioxidant and the type of the benzophenone UV absorbent are changed as in Table 5.

### Examples 3-11 to 3-20

Electrophotographic photoreceptors are produced in the same manner as in Example 3-9 except that the type of the charge-transporting materials, the type of the hindered phenol antioxidant and the type of the benzophenone UV absorbent are changed as in Table 5.

### Examples 3-21 to 3-25

Electrophotographic photoreceptors are produced in the same manner as in Example 3-20 except that the amount of the hindered phenol antioxidant and the amount of the benzophenone UV absorbent are changed as in Table 5.

### Examples 3-26 to 3-28

Electrophotographic photoreceptors are produced in the same manner as in Example 3-20 except that the amount of the charge-transporting materials is changed as in Table 5.

### Examples 3-29 to 3-31

Electrophotographic photoreceptors are produced in the same manner as in Example 3-20 except that the amount of the fluorine-containing resin particles and the amount of the fluorine-containing dispersant are changed as in Table 5.

### Comparative Examples 3-1 to 3-6

Electrophotographic photoreceptors are produced in the same manner as in Example 3-9 except that the type of the charge-transporting materials, the type of the antioxidant and the type of the UV absorbent are changed as in Table 6.

### [Evaluation]

The electrophotographic photoreceptors produced in Examples are evaluated in point of “burn-in ghosting”, “optical fatigue” and “halftone image density”, according to the manner described below.

### (Evaluation of Burn-in Ghosting)

The electrophotographic photoreceptor produced in each Example is mounted on an electrophotographic image forming apparatus (Versant 2100 Press, manufactured by Fuji Xerox, Co., Ltd.), a lattice pattern chart is continuously outputted on 3000 sheets of A3-size paper to give 3000 copies of the pattern chart, and thereafter a full-page halftone image (a full-page halftone image of cyan color) having an image density of 20% is outputted on one sheet of A3-size paper to give one copy of the image.

Thus outputted, the full-page halftone image is observed, and the density difference between the continuous image-outputted part and the discontinuous image-outputted part of the lattice pattern is visually determined for organoleptic evaluation (grade judgment). The grade judgment covers from 0G to 5G at intervals of 0.5G. In the test, the samples having a smaller numerical value G are to have a smaller density difference and therefore suffer from little burn-in ghosting. The acceptable grade of burn-in ghosting is 3.5G or less. In every case, image outputting is in an environment at 28° C. and 85% RH. The results are shown in Table 5 and Table 6.

### (Evaluation of Optical Fatigue)

First, the electrophotographic photoreceptor produced in each Example is wound around a black paper having a 2-cm square window formed therein, and left under a white fluorescent lamp (1000 lux) for 10 minutes in such a manner that only the window part thereof could be subjected to environmental light exposure, whereby the electrophotographic photoreceptor is exposed to environmental light.

Next, the thus-exposed electrophotographic photoreceptor is mounted on an electrophotographic image forming apparatus (Versant 2100 Press, manufactured by Fuji Xerox, Co., Ltd.), and a full-page halftone image (cyan) having an image density of 50% is outputted on one sheet of A3-size paper to give one copy of the image.

Thus outputted, the full-page halftone image is observed, and the density difference between the part exposed to environmental light and the part not exposed to environmental light is visually determined for organoleptic evaluation (grade judgment). The grade judgment covers from 0G to 5G at intervals of 0.5G. In the test, the samples having a smaller numerical value G are to have a smaller density difference and therefore suffer from little optical fatigue. The acceptable grade of optical fatigue is 3.5G or less. In every case, image outputting is in an environment at 28° C. and 85% RH. The results are shown in Table 5 and Table 6.

### (Evaluation of Halftone Image Density)

The electrophotographic photoreceptor produced in each Example is mounted on an electrophotographic image forming apparatus (Versant 2100 Press, manufactured by Fuji Xerox Co., Ltd.), and a full-page halftone image (cyan) having an image density of 50% is outputted on one sheet of A3-size paper to give one copy of the image.

Thus outputted, the full-page halftone image is observed and checked as to whether the intended image density could be outputted on the sheet. In every case, image outputting is in an environment at 28° C. and 85% RH. The results are shown in Table 5 and Table 6.

Examples and Comparative Examples, and also the evaluation results in those Examples are shown as tabulated records in Table 5 and Table 6. In Table 5 and Table 6, the column of “amount (% by weight)” of the antioxidant and the UV absorbent indicates the ratio thereof to 100% by weight of the total amount of all the charge-transporting materials in each Example.

TABLE 5

| | Fluororesin | | | Charge-Transporting Material | | | | | | |
|---|---|---|---|---|---|---|---|---|---|---|
| | Fluorine- | Fluorine- | | | | | | (CT2) | | |
| | Containing | Containing | | (CT1) | | | | Exemplified | Amount | ratio by |
| | Resin Particles | Dispersant | | Exemplified | | Amount | | Compound | (number | weight |
| | (number of parts) | (number of parts) | | Compound No. | | (number of parts) | | No. | of parts) | of CT1/CT2 |
| Example 3-1 | 8 | 3 | | CT1-1 | | 8 | | CT2-1 | 32 | 1/4 |
| Example 3-2 | 8 | 3 | | CT1-1 | | 8 | | CT2-1 | 32 | 1/4 |
| Example 3-3 | 8 | 3 | | CT1-2 | | 8 | | CT2-1 | 32 | 1/4 |
| Example 3-4 | 8 | 3 | | CT1-2 | | 8 | | CT2-1 | 32 | 1/4 |
| Example 3-5 | 8 | 3 | | CT1-1 | | 8 | | CT2-1 | 32 | 1/4 |
| Example 3-6 | 8 | 3 | | CT1-1 | | 8 | | CT2-1 | 32 | 1/4 |
| Example 3-7 | 8 | 3 | | CT1-2 | | 8 | | CT2-1 | 32 | 1/4 |
| Example 3-8 | 8 | 3 | | CT1-2 | | 8 | | CT2-1 | 32 | 1/4 |
| Example 3-9 | 8 | 3 | | CT1-1 | | 8 | | CT2-1 | 32 | 1/4 |
| Example 3-10 | 8 | 3 | | CT1-1 | | 8 | | CT2-1 | 32 | 1/4 |
| Example 3-11 | 8 | 3 | | CT1-3 | | 8 | | CT2-1 | 32 | 1/4 |
| Example 3-12 | 8 | 3 | | CT1-3 | | 8 | | CT2-1 | 32 | 1/4 |
| Example 3-13 | 8 | 3 | | CT1-3 | | 8 | | CT2-1 | 32 | 1/4 |
| Example 3-14 | 8 | 3 | | CT1-3 | | 8 | | CT2-1 | 32 | 1/4 |
| Example 3-15 | 8 | 3 | | CT1-3 | | 8 | | CT2-2 | 32 | 1/4 |
| Example 3-16 | 8 | 3 | | CT1-3 | | 8 | | CT2-2 | 32 | 1/4 |
| Example 3-17 | 8 | 3 | | CT1-3 | | 8 | | CT2-2 | 32 | 1/4 |
| Example 3-18 | 8 | 3 | | CT1-3 | | 8 | | CT2-2 | 32 | 1/4 |
| Example 3-19 | 8 | 3 | | CT1-3 | | 8 | | CT2-2 | 32 | 1/4 |
| Example 3-20 | 8 | 3 | | CT1-3 | | 8 | | CT2-2 | 32 | 1/4 |
| Example 3-21 | 8 | 3 | | CT1-3 | | 8 | | CT2-2 | 32 | 1/4 |
| Example 3-22 | 8 | 3 | | CT1-3 | | 8 | | CT2-2 | 32 | 1/4 |
| Example 3-23 | 8 | 3 | | CT1-3 | | 8 | | CT2-2 | 32 | 1/4 |
| Example 3-24 | 8 | 3 | | CT1-3 | | 8 | | CT2-2 | 32 | 1/4 |
| Example 3-25 | 8 | 3 | | CT1-3 | | 8 | | CT2-2 | 32 | 1/4 |
| Example 3-26 | 8 | 3 | | CT1-3 | | 16 | | CT2-2 | 24 | 2/3 |
| Example 3-27 | 8 | 3 | | CT1-3 | | 20 | | CT2-2 | 20 | 1/1 |
| Example 3-28 | 8 | 3 | | CT1-3 | | 24 | | CT2-2 | 16 | 3/2 |
| Example 3-29 | 8 | 10 | | CT1-3 | | 8 | | CT2-2 | 32 | 1/4 |
| Example 3-30 | 8 | 1 | | CT1-3 | | 8 | | CT2-2 | 32 | 1/4 |
| Example 3-31 | 10 | 0.3 | | CT1-3 | | 8 | | CT2-2 | 32 | 1/4 |
| | Antioxidant | | | | UV Absorbent | | | Evaluation | | |
| | | | Amount | | Exemplified | Amount | | | | Halftone |
| | Exemplified | Molecular | (number | Amount | Compound | (number | Amount | Burn-in | Optical | Image |
| | Compound No. | Weight | of parts) | (wt %) | No. | of parts) | (wt %) | Ghosting | Fatigue | density |
| Example 3-1 | HP-1 | 775 | 3.2 | 8 | none | 0 | 0 | 3.5 G | 3.5 G | good |
| Example 3-2 | HP-2 | 784 | 3.2 | 8 | none | 0 | 0 | 3.5 G | 3.5 G | good |
| Example 3-3 | HP-1 | 775 | 3.2 | 8 | none | 0 | 0 | 3.5 G | 3.5 G | good |
| Example 3-4 | HP-2 | 784 | 3.2 | 8 | none | 0 | 0 | 3.5 G | 3.5 G | good |
| Example 3-5 | none | — | 0 | 0 | BP-1 | 3.2 | 8 | 3.5 G | 3.5 G | good |
| Example 3-6 | none | — | 0 | 0 | BP-2 | 3.2 | 8 | 3.5 G | 3.5 G | good |
| Example 3-7 | none | — | 0 | 0 | BP-1 | 3.2 | 8 | 3.5 G | 3.5 G | good |
| Example 3-8 | none | — | 0 | 0 | BP-2 | 3.2 | 8 | 3.5 G | 3.5 G | good |
| Example 3-9 | HP-1 | 775 | 3.2 | 8 | BP-1 | 3.2 | 8 | 3.5 G | 3.5 G | good |
| Example 3-10 | HP-2 | 784 | 3.2 | 8 | BP-2 | 3.2 | 8 | 3.5 G | 3.5 G | good |
| Example 3-11 | HP-1 | 775 | 3.2 | 8 | none | 0 | 0 | 3.5 G | 3.5 G | good |
| Example 3-12 | none | — | 0 | 0 | BP-1 | 3.2 | 8 | 3.5 G | 3.5 G | good |
| Example 3-13 | HP-1 | 775 | 3.2 | 8 | BP-1 | 3.2 | 8 | 3.5 G | 3.5 G | good |
| Example 3-14 | HP-1 | 775 | 3.2 | 8 | none | 0 | 0 | 3.5 G | 3.5 G | good |
| Example 3-15 | none | — | 0 | 0 | BP-1 | 3.2 | 8 | 3.5 G | 3.5 G | good |
| Example 3-16 | HP-1 | 775 | 3.2 | 8 | BP-1 | 3.2 | 8 | 3.0 G | 3.0 G | good |
| Example 3-17 | HP-3 | 340 | 3.2 | 8 | none | 0 | 0 | 3.0 G | 3.0 G | good |
| Example 3-18 | HP-3 | 340 | 3.2 | 8 | BP-1 | 3.2 | 8 | 2.5 G | 2.5 G | good |
| Example 3-19 | HP-3 | 340 | 3.2 | 8 | none | 0 | 0 | 2.0 G | 2.0 G | good |
| Example 3-20 | HP-3 | 340 | 3.2 | 8 | BP-3 | 3.2 | 8 | 1.5 G | 1.5 G | good |
| Example 3-21 | HP-3 | 340 | 4.8 | 12 | BP-3 | 4.8 | 12 | 1.5 G | 1.5 G | slightly pale |
| Example 3-22 | HP-3 | 340 | 5.8 | 14.5 | BP-3 | 5.8 | 14.5 | 1.5 G | 1.5 G | slightly pale |
| Example 3-23 | HP-3 | 340 | 6.4 | 16 | BP-3 | 6.4 | 16 | 1.5 G | 1.5 G | somewhat pale |
| Example 3-24 | HP-3 | 340 | 11.6 | 29 | BP-3 | 11.6 | 29 | 1.5 G | 1.5 G | somewhat pale |
| Example 3-25 | HP-3 | 340 | 12.5 | 30.3 | BP-3 | 12.5 | 30.3 | 1.5 G | 1.5 G | pale |
| Example 3-26 | HP-3 | 340 | 3.2 | 8 | BP-3 | 3.2 | 8 | 1.5 G | 1.0 G | good |
| Example 3-27 | HP-3 | 340 | 3.2 | 8 | BP-3 | 3.2 | 8 | 2.0 G | 2.0 G | good |
| Example 3-28 | HP-3 | 340 | 3.2 | 8 | BP-3 | 3.2 | 8 | 2.0 G | 2.0 G | good |
| Example 3-29 | HP-3 | 340 | 3.2 | 8 | BP-3 | 3.2 | 8 | 3.0 G | 3.0 G | somewhat pale |
| Example 3-30 | HP-3 | 340 | 3.2 | 8 | BP-3 | 3.2 | 8 | 1.0 G | 1.0 G | good |
| Example 3-31 | HP-3 | 340 | 3.2 | 8 | BP-3 | 3.2 | 8 | 0 G | 0 G | good |

TABLE 6

| | Fluororesin | | | Charge-Transporting Material | | | | | | |
|---|---|---|---|---|---|---|---|---|---|---|
| | Fluorine- | Fluorine- | | (CT1) | | | (CT2) | | | |
| | Containing Resin | Containing | | | | Amount | | | Amount | ratio by |
| | Particles | Dispersant | | Exemplified | | (number of | Exemplified | | (number of | weight of |
| | (number of parts) | (number of parts) | | Compound No. | | parts) | Compound No. | | parts) | CT1/CT2 |
| Comparative | 8 | 3 | | CT1-3 | | 8 | CT2-2 | | 32 | 1/4 |
| Example 3-1 | | | | | | | | | | |
| Comparative | 8 | 3 | | none | | 0 | CT2-2 | | 40 | 0/40 |
| Example 3-2 | | | | | | | | | | |
| Comparative | 8 | 3 | | CT1-3 | | 8 | CT2-2 | | 32 | 1/4 |
| Example 3-3 | | | | | | | | | | |
| Comparative | 8 | 3 | | CT1-3 | | 8 | CT2-2 | | 32 | 1/4 |
| Example 3-4 | | | | | | | | | | |
| Comparative | 8 | 3 | | CT1-3 | | 8 | CT2-2 | | 32 | 1/4 |
| Example 3-5 | | | | | | | | | | |
| Comparative | 8 | 3 | | CT1-3 | | 8 | CT2-2 | | 32 | 1/4 |
| Example 3-6 | | | | | | | | | | |
| | Antioxidant | | | | UV Absorbent | | | Evaluation | | |
| | | | Amount | | | Amount | | | | Halftone |
| | Exemplified | Molecular | (number | Amount | Exemplified | (number | Amount | Burn-in | Optical | Image |
| | Compound No. | Weight | of parts) | (wt %) | Compound No. | of parts) | (wt %) | Ghosting | Fatigue | density |
| Comparative | none | — | 0 | 0 | none | 0 | 0 | 5.0 G | 5.0 G | good |
| Example 3-1 | | | | | | | | | | |
| Comparative | HP-3 | 340 | 3.2 | 8 | BP-3 | 3.2 | 8 | undeterminable | undeterminable | density |
| Example 3-2 | | | | | | | | | | insufficiency |
| Comparative | CAO-1 | 220 | 3.2 | 8 | none | 0 | 0 | 5.0 G | 5.0 G | good |
| Example 3-3 | | | | | | | | | | |
| Comparative | none | — | 0 | 0 | CUA-1 | 3.2 | 8 | 5.0 G | 5.0 G | good |
| Example 3-4 | | | | | | | | | | |
| Comparative | CAO-1 | 220 | 3.2 | 8 | CUA-1 | 3.2 | 8 | 5.0 G | 5.0 G | good |
| Example 3-5 | | | | | | | | | | |
| Comparative | CAO-2 | — | 3.2 | 8 | none | 0 | 0 | 5.0 G | 5.0 G | good |
| Example 3-6 | | | | | | | | | | |

From the above results, it is known that in Examples 3-1 to 3-31, the troubles of “burn-in ghosting” and “optical fatigue” are prevented as compared with those in Comparative Examples 3-1 to 3-6.

In addition, it is known that, in Examples 3-1 to 3-20 where the compounding amount of the hindered phenol antioxidant and that of the benzophenone UV absorbent are suitable, the intended halftone image density is obtained as compared with that in Examples 3-21 to 3-25.

The details of the abbreviations in Table 1 to Table 6 are as follows.

CT1-1: Exemplified compound (CT1-1) of butadiene charge-generating material (CT1)

CT1-2: Exemplified compound (CT1-2) of butadiene charge-generating material (CT1)

CT1-3: Exemplified compound (CT1-3) of butadiene charge-generating material (CT1)

CT2-1: Exemplified compound (CT2-1) of benzidine charge-generating material (CT2)

CT2-2: Exemplified compound (CT2-2) of benzidine charge-generating material (CT2)

PC-1: Exemplified compound (PC-1) of BP polycarbonate resin

PC-2: Exemplified compound (PC-2) of BP polycarbonate resin

PC-3: Exemplified compound (PC-3) of BP polycarbonate resin

PCZ500: Bisphenol Z-type polycarbonate resin (bisphenol Z homopolymer-type polycarbonate resin, viscosity-average molecular weight 50.000)

HP-1: Exemplified compound (HP-1) of hindered phenol antioxidant

HP-2: Exemplified compound (HP-2) of hindered phenol antioxidant

HP-3: Exemplified compound (HP-3) of hindered phenol antioxidant

CAO-1: Comparative compound of antioxidant (hindered phenol antioxidant represented by the following structural formula (CAO-1))

CAO-2: Comparative compound of antioxidant (hindered phenol antioxidant represented by the following structural formula (CAO-2))

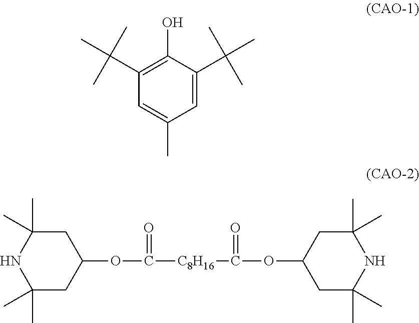

BP-1: Exemplified compound (BP-1) of benzophenone UV absorbent

BP-2: Exemplified compound (BP-2) of benzophenone UV absorbent

BP-3: Exemplified compound (BP-3) of benzophenone UV absorbent

CUA-1: Comparative compound of UV absorbent (benzoate UV absorbent represented by the following structural formula (CUA-1))

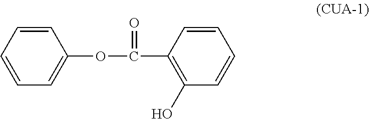 [SMILES: O=C(Oc1ccccc1)c1ccccc1O]

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. An electrophotographic photoreceptor comprising:
a conductive substrate; and
a photosensitive layer arranged on the conductive substrate,
wherein the photosensitive layer contains a charge-generating material, a charge-transporting material represented by formula (CT1), a charge-transporting material represented by formula (CT2), and at least one selected from the group consisting of a hindered phenol antioxidant having a molecular weight of 300 or more and a benzophenone UV absorbent: 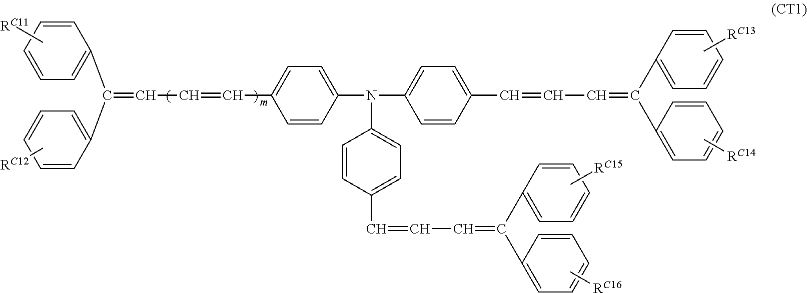
wherein R^{C11}, R^{C12}, R^{C13}, R^{C14}, R^{C15} and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, and adjacent two substituents may bond to each other to form a alicyclic structure, and
n and m each independently indicate 0, 1 or 2: 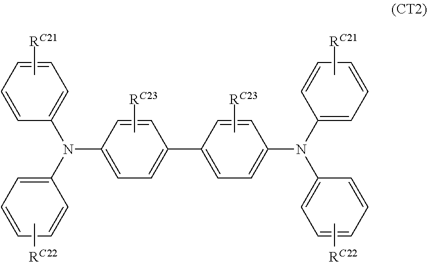
wherein R^{C21}, R^{C22} and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

2. The electrophotographic photoreceptor according to claim 1,
wherein the photosensitive layer further contains a biphenyl copolymer-type polycarbonate resin including a structural unit having a biphenyl skeleton.

3. The electrophotographic photoreceptor according to claim 2,
wherein the biphenyl copolymer-type polycarbonate resin is a polycarbonate resin including a structural unit represented by formula (PCA) and a structural unit represented by formula (PCB): 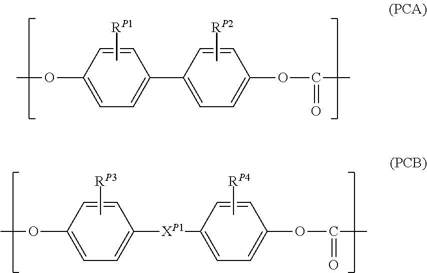
wherein R^{P1}, R^{P2}, R^{P3} and R^{P4} each independently represent a hydrogen atom, a halogen atom, an alkyl group having from 1 to 6 carbon atoms, a cycloalkyl group having from 5 to 7 carbon atoms, or an aryl group having from 6 to 12 carbon atoms, and
X^{P1} represents a phenylene group, a biphenylene group, a naphthylene group, an alkylene group, or a cycloalkylene group.

4. The electrophotographic photoreceptor according to claim 1,
wherein the photosensitive layer further contains fluorine-containing resin particles and a fluorine-containing dispersant.

5. The invention electrophotographic photoreceptor according to claim 1,
wherein, in the charge-transporting material represented by formula (CT1), R^{C11}, R^{C12}, R^{C13}, R^{C14}, R^{C15} and R^{C16} each are a hydrogen atom, and
m and n each are 1.

6. The electrophotographic photoreceptor according to claim 1,
wherein, in the charge-transporting material represented by formula (CT2), R^{C21} and R^{C23} each are a hydrogen atom, and
R^{C22} is an alkyl group having from 1 to 10 carbon atoms.

7. The electrophotographic photoreceptor according to claim 1,
wherein the hindered phenol antioxidant is an antioxidant represented by formula (HP): 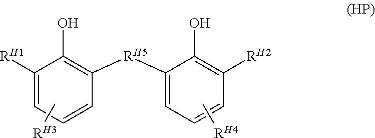
wherein R^{H1} and R^{H2} each independently represent a branched alkyl group having from 4 to 8 carbon atoms,
R^{H3} and R^{H4} each independently represent a hydrogen atom, or an alkyl group having from 1 to 10 carbon atoms, and
R^{H5} represents an alkylene group having from 1 to 10 carbon atoms.

8. The electrophotographic photoreceptor according to claim 7,
wherein, in the antioxidant represented by the general formula (HP), R^{H1} and R^{H2} each are a tert-butyl group.

9. The electrophotographic photoreceptor according to claim 1,
wherein the benzophenone UV absorbent is a UV absorbent represented by formula (BP): 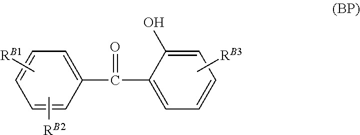
wherein R^{B1}, R^{B2} and R^{B3} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

10. The electrophotographic photoreceptor according to claim 9,
wherein, in the benzophenone UV absorbent represented by formula (BP), R^{B1} and R^{B2} each are a hydrogen atom, and
R^{B3} is an alkoxy group having from 1 to 4 carbon atoms.

11. The electrophotographic photoreceptor according to claim 1,
wherein the charge-generating material is a hydroxygallium phthalocyanine pigment.

12. A process cartridge attachable and detachable to/from an image forming apparatus, comprising the electrophotographic photoreceptor according to claim 1.

13. An image forming apparatus comprising:
the electrophotographic photoreceptor according to claim 1,
a charging unit of charging a surface of the electrophotographic photoreceptor,
an electrostatic latent image formation unit of forming an electrostatic latent image on the surface charged of the electrophotographic photoreceptor,
a development unit of developing the electrostatic latent image formed on the surface of the electrophotographic photoreceptor by using a developer containing a toner to form a toner image, and
a transfer unit of transferring the toner image to a surface of a recording medium.
